(19) United States
(12) Patent Application Publication
(10) Pub. No.: US 2026/0082351 A1
(43) Pub. Date: Mar. 19, 2026

(54) RADIO FREQUENCY IDENTIFICATION RANGING USING PHASE-BASED RANGING WITH CHANNEL HOPPING

(71) Applicant: QUALCOMM Incorporated, San Diego, CA (US)

(72) Inventors: Paul Dominic HISCOCK, Cambridge (GB); Joseph Patrick BURKE, Carlsbad, CA (US); Sumit AGRAWAL, San Diego, CA (US); Sheng-Yuan TU, San Diego, CA (US)

(21) Appl. No.: 18/886,767

(22) Filed: Sep. 16, 2024

(51) Int. Cl. H04W 64/00; H04B 5/73; H04L 5/00

(52) U.S. Cl. CPC H04W 64/00; H04B 5/73; H04L 5/0012

(57) ABSTRACT

Systems and techniques are provided for wireless communications. For example, a process can include determining a frequency hopping configuration corresponding to a plurality of frequency hops between a plurality of carrier frequencies, and transmitting a continuous carrier signal to a Radio Frequency Identification (RFID) tag, where the continuous carrier signal comprises a pilot tone transmitted on each respective carrier frequency of the plurality of carrier frequencies. A process can include receiving, from the RFID tag, a continuous backscatter signal including a corresponding reflection of the pilot tone transmitted on each respective carrier frequency of the plurality of carrier frequencies. A process can include determining an estimated distance from a wireless communication device to the RFID tag based on a plurality of measurements obtained from the continuous backscatter signal.

### FIELD OF THE DISCLOSURE

The present disclosure generally relates to wireless communications. For example, aspects of the present disclosure relate to radio frequency identification (RFID) ranging, and more particularly relate to phase-based ranging (PBR) between an RFID reader device and an RFID tag using channel hopping for a carrier frequency between the RFID reader device and the RFID tag.

### BACKGROUND

Short range wireless communication enables wireless communication over relatively short distances (e.g., within thirty meters). For example, Radio Frequency Identification (RFID) systems can be used to perform short range wireless communication based on the wireless transfer of data between a reader (e.g., RFID reader device) and a tag or transponder (e.g., RFID tag). RFID systems can be used for identification, tracking, data storage, etc. For example, RFID systems can be used to identify and/or track various items, such as warehouse boxes or consumer products.

An RFID tag may be attached to an item to be tracked and may include data storage and an antenna. The data storage stores information corresponding to the associated item, such as a product name, a serial number, product information, a manufacturer, etc. The antenna enables the RFID tag to be read by an RFID reader, which transmits an interrogating signal to one or more RFID tags within communication range. RFID tags can be passive, active, semi-passive or semi-active. Passive RFID tags utilize the interrogating signal from an RFID reader to power a transmission by or from the RFID tag. Active, semi-passive and semi-active RFID tags can include a power source or battery, which can be used to power a transmission by or from the RFID tag.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a method of wireless communications is provided, the method comprising: determining a frequency hopping configuration corresponding to a plurality of frequency hops between a plurality of carrier frequencies; transmitting a continuous carrier signal to a Radio Frequency Identification (RFID) tag, wherein the continuous carrier signal comprises a pilot tone transmitted on each respective carrier frequency of the plurality of carrier frequencies; receiving, from the RFID tag, a continuous backscatter signal including a corresponding reflection of the pilot tone transmitted on each respective carrier frequency of the plurality of carrier frequencies; and determining an estimated distance from a wireless communication device to the RFID tag based on a plurality of measurements obtained from the continuous backscatter signal.

In another example, an apparatus for wireless communications is provided. The apparatus includes at least one memory and at least one processor coupled to the at least one memory and configured to: determine a frequency hopping configuration corresponding to a plurality of frequency hops between a plurality of carrier frequencies; transmit a continuous carrier signal to a Radio Frequency Identification (RFID) tag, wherein the continuous carrier signal comprises a pilot tone transmitted on each respective carrier frequency of the plurality of carrier frequencies; receive, from the RFID tag, a continuous backscatter signal including a corresponding reflection of the pilot tone transmitted on each respective carrier frequency of the plurality of carrier frequencies; and determine an estimated distance from the wireless communication device to the RFID tag based on a plurality of measurements obtained from the continuous backscatter signal.

In another example, a non-transitory computer-readable medium is provided that includes instructions that, when executed by at least one processor, cause the at least one processor to: determine a frequency hopping configuration corresponding to a plurality of frequency hops between a plurality of carrier frequencies; transmit a continuous carrier signal to a Radio Frequency Identification (RFID) tag, wherein the continuous carrier signal comprises a pilot tone transmitted on each respective carrier frequency of the plurality of carrier frequencies; receive, from the RFID tag, a continuous backscatter signal including a corresponding reflection of the pilot tone transmitted on each respective carrier frequency of the plurality of carrier frequencies; and determine an estimated distance from the wireless communication device to the RFID tag based on a plurality of measurements obtained from the continuous backscatter signal.

In another example, an apparatus for wireless communications is provided. The apparatus includes: means for determining a frequency hopping configuration corresponding to a plurality of frequency hops between a plurality of carrier frequencies; means for transmitting a continuous carrier signal to a Radio Frequency Identification (RFID) tag, wherein the continuous carrier signal comprises a pilot tone transmitted on each respective carrier frequency of the plurality of carrier frequencies; means for receiving, from the RFID tag, a continuous backscatter signal including a corresponding reflection of the pilot tone transmitted on each respective carrier frequency of the plurality of carrier frequencies; and means for determining an estimated distance from a wireless communication device to the RFID tag based on a plurality of measurements obtained from the continuous backscatter signal.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example of a wireless communication network, in accordance with some examples;

FIG. 2 is a diagram illustrating example components of a device, in accordance with some examples;

FIG. 3 is a diagram illustrating an example of an RFID system, in accordance with some examples;

FIG. 4A is a diagram illustrating an example of an RFID system that can be used for phase-based ranging (PBR) distance estimation, in accordance with some examples;

FIG. 4B is a diagram illustrating an example of PBR-based distance estimation using a plurality of RFID phase measurements, in accordance with some examples;

FIG. 5A is a diagram illustrating an example of an RFID reader device and an RFID tag associated with an example RFID ranging measurement, in accordance with some examples;

FIG. 5B is a diagram illustrating an example of RFID communications between an RFID reader device and an RFID tag where the RFID tag backscatters a pilot tone transmitted by the RFID reader device using a plurality of different transmitted carrier frequencies, in accordance with some examples;

FIG. 5C is a diagram illustrating an example of PBR-based distance estimation using a plurality of RFID phase measurements obtained based on the RFID communications of FIG. 5B, in accordance with some examples;

FIG. 6A is a diagram illustrating an example of link timing associated with RFID communications between an RFID reader device and an RFID tag, in accordance with some examples;

FIG. 6B is a diagram illustrating an example reader-to-tag preamble of a query message transmitted from an RFID reader device to an RFID tag, in accordance with some examples;

FIG. 7 is a diagram illustrating an example of frequency hopping performed by an RFID reader device and corresponding to symbol boundaries of an RFID tag-to-reader preamble for phase-based ranging, in accordance with some examples;

FIG. 8 is a flowchart diagram illustrating an example of a process for wireless communications, in accordance with some examples; and

FIG. 9 is a block diagram illustrating an example of a computing system, which may be employed by the disclosed systems and techniques, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Radio Frequency Identification (RFID) systems can be used for short range wireless communication between a reader device (e.g., RFID reader) and one or more tags or transponders (e.g., RFID tags). An RFID reader may also be referred to as an “RFID interrogator,” and “RFID scanner,” and/or an “energizer.” RFID systems can be used to identify and/or track various items that are associated with one or more RFID tags (e.g., various items to which one or more RFID tags are attached). RFID systems can read and/or write information to and/or from (respectively) RFID tags, based on respective wireless communications between an RFID reader and the RFID tags.

For example, an RFID reader (e.g., energizer) can be used to interrogate one or more RFID tags to obtain information of the nearby items that are within communication range of the RFID reader and the interrogation signal. The RFID reader (e.g., energizer) can transmit a radio frequency (RF) signal to perform the energizing and interrogating of the RFID tags. An RFID tag that receives the interrogating RF wave can respond by backscattering (e.g., reflecting back) and/or transmitting another RF wave. An RFID tag may generate the responsive RF wave originally (e.g., in examples where the RFID tag is an active or semi-active tag). An RFID tag may generate the responsive RF wave passively, for instance by reflecting back a portion of the interrogating RFID wave using a backscatter process (e.g., in examples where the RFID tag is a passive tag).

In some examples (e.g., such as in product-related and/or service-related industries, etc.), RFID systems can be used to track objects that are being processed, inventoried, shipped, handled, etc. For example, an RFID tag can be attached to an individual item (e.g., to the packaging of an individual item, etc.) to provide tracking and identification of the individual item. In some examples, an RFID tag can be attached to a collection or group of individual items (e.g., to a pallet of same or similar items being shipped to a store or distribution center, etc.).

An RFID tag attached to a respective item, or attached to a group of items, may store corresponding information thereof. For example, an RFID tag can include a data storage element that stores information corresponding to the item(s) to which the RFID is attached and associated. For instance, RFID tag information can include one or more of a product name, a serial number, product information, a manufacturer, etc. In some examples, the RFID tag can store identification information that is directly indicative of a tagged item, product, object, etc. For instance, an RFID tag can store identification information such as a unique product serial number, etc. In some examples, the RFID tag does not store product or item identification information directly, and stores a unique RFID tag serial number or identification number which may be externally mapped to various item identification information such as product serial numbers, product names, product SKUs, etc.

An RFID reader (e.g., energizer) can transmit an RF signal configured to cause the RFID tags to transmit at least a portion of their respective identification information. The RFID reader can receive (e.g., scan) the identification information transmitted by the one or more RFID tags energized by the RFID reader, and can use the identification information to determine the tagged items or products that are nearby to the RFID reader.

In some examples, RFID tags can store item identification information that utilizes various granularity levels for tracking and management of the RFID tagged items. For example, RFID tags can be used to track item types or models by using different RFID tags (e.g., unique identifiers) per item type or item model, with RFID identifier reuse across individual tagged items that are of the same type or model. For instance, the RFID tags used for each item of a particular type may store the same product identifier, and can be used to decrement an inventory count for the particular item whenever a tag is scanned and removed from the shelf, from the store, etc.

In another example, RFID tags can be used to track and identify individual items, based on using a corresponding RFID tag and unique identifier for each individual item of a plurality of RFID-tagged items that are registered with the RFID system. In some examples, individual and unique item identifiers can be implemented based on using individual and unique RFID tag serial numbers or identifiers, which may be mapped separately to a corresponding individual item. In some examples, individual and unique item identifiers can be implemented based on using a product type identifier combined with a unique identifier within that product type. For instance, items can be tagged with their corresponding product SKU and a unique identifier of each item within the corresponding product SKU. In some cases, the unique RFID tag identifiers can be mapped in one or more databases to additional information associated with an item, such as manufacturing data, batch number, specific store location, etc.

RFID systems can be used in a retail environment for purposes such as inventory tracking (e.g., determining when items are removed from shelves, which particular items are removed from shelves and the quantity thereof, etc.). RFID systems can also be used in a retail environment for determining the contents of a container (e.g., a basket, box, or other type of container of a consumer or person shopping for items), for instance based on reading the RFID tags of items as they are placed in the container, reading the RFID tags of the items once they are within the container, reading the RFID tags of the items during the checkout process or as the final collection of items is removed from the container, etc. As used herein, a “container” can refer to any receptacle or volume within which items are placed for temporary storage and/or transport (e.g., prior to purchase of the items). For example, a container can include various implementations, such as a basket (e.g., a handheld basket), a cart or trolley, a bag or satchel, a box, etc. A “container” or “container contents” may also refer to the hand carry of one or more items carried by a person. In some aspects, a container or container volume may refer to a car, vehicle, automobile, etc., having a receptable or volume within which items are placed for temporary storage and/or transport (e.g., including for transportation to and/or from a retail environment or other point of sale of the RFID-tagged items, etc.).

RFID readers can be configured to read hundreds of RFID tags per second, based on the respective RFID tags responding to an interrogation signal from the RFID reader using a corresponding time slot determined for the respective RFID tag. The time slot used by an RFID tag may be assigned by the RFID reader, or may be determined by the RFID tags. For example, RFID tags can respond to an interrogation signal based on randomly choosing a time slot within a configured time window for response. In some cases, an anti-collision algorithm can be used to divide a time window into a plurality of discrete time slots for RFID tag responses, within which each RFID tag may randomly choose or be assigned a particular time slot. Each RFID tag transmits its identification information back to the reader in the corresponding or allocated time slot for the RFID tag. Restricting each RFID tag to a particular time slot reduces the chances of a collision occurring when two or more RFID tags attempt to transmit during the same time slot. If a collision occurs, the multiple RFID tags attempting to transmit during the same time slot are not successfully read by the RFID reader, and may be configured to select new time slots and retransmit.

RFID systems may commonly be implemented without the capability to perform selective reporting. Selective reporting can be associated with an RFID reader that reports only information associated with RFID tags of interest, where the RFID tags of interest are a subset within a larger plurality of RFID tag reflections that are read by the RFID reader. For example, a non-selective RFID reader will report the reflected information read for any RFID tag that is within range to respond to the interrogation signal(s) from the reader. A selective RFID reader can perform selective reporting to filter the reflected information received from a plurality of RFID tags and report only the corresponding information associated with a subset of interest. However, the selective reporting of RFID tag identification information does not suppress RFID tags that are not of interest (e.g., not included in the subset of interest) from responding to the interrogation signal (e.g., the RFID tags not of interest will still respond and consume a time slot). Additionally, in some examples it can be difficult or impossible to determine in advance which RFID tags belong to the subset of interest and which RFID tags do not belong to the subset of interest. For example, in use cases such as a determination of contents in a container of a person shopping (e.g., identifying the products placed into a shopper's basket in a store), a primary task for which the RFID system is utilized may be to determine the subset of interest comprising RFID tags of items selected for purchase by the person and placed into the container.

In some cases, an RFID system can utilize one or more RFID readers (e.g., energizers) with antenna configurations that are adjusted to limit the reading range and/or reading zone. For example, an RFID reader can be configured with a reading zone that corresponds to an angular section of an omnidirectional or 360° reading zone. The selective reading of RFID tags based on antenna configurations of an RFID reader can be challenging when the spatial relationship between the RFID reader(s) and the RFID tag(s) is unknown and/or changing. For example, in a container content determination example, the relative spatial positions of the RFID reader and the RFID tags in a container (e.g., a shopper's basket) can vary, and/or the relative spatial positions of the RFID reader and the RFID tags of items in an environment (e.g., items located on shelves in a store) can vary.

In some examples, selective RFID tag reading can be performed based on measuring the respective signal strength of reply transmissions received by an RFID reader from nearby RFID tags (e.g., the nearby RFID tags receiving an energizing or interrogation signal from the RFID reader). For example, an RFID reader can be configured to determine a respective Received Signal Strength Indicator (RSSI) value for each reflected signal received from an RFID tag (e.g., passive RFID tag) in response to an energizing signal used by the RFID reader to interrogate and scan nearby tags. The RSSI value can be indicative of the power level of the reflected signal received by an antenna of the RFID reader, where a larger RSSI value corresponds to a stronger reflected signal.

In some cases, RFID ranging or distance estimation between the RFID reader and a plurality of RFID tags can be implemented based on the respective RSSI value determined for the reflected signal(s) from each RFID tag, where a larger RSSI value is associated with a shorter distance between the RFID reader and the corresponding RFID tag. For example, based on a placement of the RFID reader (e.g., energizer) on, within, or nearby to the container, one or more signal strength thresholds can be used to filter the RFID tag identification information of the contents in the container from the background noise of unwanted RFID tags corresponding to items in the environment (e.g., items on the shelves) or otherwise not within the container contents.

The location accuracy of RSSI-based location or ranging estimates can be relatively low, for example on the order of 5-10 meter (m) accuracy. In a retail environment (or other densely populated RFID environment), a 5-10 m location and ranging accuracy can be insufficient to perform reliable and accurate inventory estimation for RFID tagged items. For example, a 5-10 m location and ranging accuracy may be insufficient for estimating the contents in a container (e.g., items in a shopping basket), as both the container contents and the surrounding shelves of RFID tagged products or items fall within the radius of error or uncertainty associated with the RSSI-based ranging estimate.

In another example, phase-based ranging (PBR) can be used to perform distance estimation between an RFID reader device and one or more RFID tags. For example, PBR-based RFID ranging or distance estimation can be performed between an RFID reader and respective RFID tags configured to backscatter a carrier wave or interrogation signal transmitted by the RFID reader. In phase-based ranging, a phase change in an RF carrier may occur based on the distance separating the two radio antennas (e.g., a first radio antenna corresponding to an RFID reader and a second radio antenna corresponding to an RFID tag). The phase change in the RF carrier can be measured and used to determine a range or distance estimate between the two radio antennas. PBR techniques may utilize multiple phase measurements between the two radio antennas, where the multiple phase measurements are made at different respective carrier frequencies. The distance or range can subsequently be determined as the gradient of a best fit line through the unwrapped phases (e.g., of the multiple phase measurements) against carrier frequency.

RFID communications between an RFID reader device and an RFID tag can be configured to utilize and/or may be performed based on determining a phase change measurement. For example, an RFID reader device can measure a single phase change on a single carrier, based on the RFID reader transmitting an RF carrier to an RFID tag that is configured to backscatter the carrier modulated with a modulated tone (e.g., 1010101010, etc.). For example, the RFID reader can measure a single phase change on a single carrier corresponding to an RFID tag response to a Query command from the RFID reader. In some cases, the RFID reader may measure a single phase difference from the modulated tone signal on either side of the DC carrier.

As noted above, PBR-based techniques for ranging and/or distance estimation between two radio antennas (e.g., between an RFID reader device and an RFID tag) may be implemented based on obtaining a plurality of phase measurements at different respective carrier frequencies. In examples where an RFID reader measures a single phase change on a single carrier (e.g., corresponding to an RFID tag response to a Query command from the RFID reader), performing PBR-based ranging may require multiple commands to be sent from the RFID reader to the RFID tag in order to obtain the multiple phase measurements that are needed for the PBR-based range or distance estimate. Each phase measurement may take several milliseconds (ms) to perform. In environments that include hundreds or thousands of RFID tags, PBR-based ranging or distance estimation can be challenging to perform using an RFID reader device that measures a single phase change on a single carrier (e.g., one phase change measurement per command or RF transmission from the RFID reader).

For example, if the PBR-based distance estimate from the RFID reader to an RFID tag is determined based on 10 phase change measurements at 10 different carrier frequencies, the RFID reader that measures a single phase change on a single carrier will sequentially transmit 10 different carriers to the RFID tag, and will measure the corresponding phase change in each respective backscatter modulated reply received from the RFID tag for each one of the 10 separate carriers.

Performing multiple transmissions between an RFID reader and an RFID tag to obtain the multiple phase change measurements for PBR-based ranging or distance estimation can decrease the available airtime for data communication and/or other RFID communications between the RFID reader and various RFID tags. Systems and techniques that can be used to perform PBR-based ranging or distance estimation using a single transmission or command between an RFID reader and an RFID tag may be beneficial. Systems and techniques that can be used to determine multiple phase change measurements corresponding to multiple carrier frequencies associated with a single command from an RFID reader to an RFID tag may also be beneficial.

Systems, apparatuses, processes (also referred to as methods), and computer-readable media (collectively referred to as “systems and techniques”) are described herein that can be used to perform RFID ranging and/or distance estimation using phase-based ranging with channel hopping. For example, the systems and techniques can be used to perform PBR-based ranging and/or distance estimation based on channel hopping performed by an RFID reader device during transmission of a tone signal to an RFID tag. The RFID reader can perform the channel hopping to switch between a plurality of different carrier frequencies during the transmission of the tone signal to the RFID tag. The RFID tag can backscatter a modulated tone signal at each respective carrier frequency of the plurality of different carrier frequencies during the transmission from the RFID reader, and the RFID reader can measure a respective phase change for each carrier frequency of the plurality of different carrier frequencies.

In some examples, the RFID reader can be configured to perform the channel hopping based on determined or estimated symbol boundary information corresponding to the modulated tone signal backscattered by the RFID tag. For example, the RFID reader can perform the channel hopping using timing information configured to switch the carrier frequency at the time corresponding to the boundary between consecutive symbols of the backscatter modulated response from the RFID tag. For example, the RFID reader channel hopping can be performed to switch from a first carrier frequency to a second carrier frequency at a time that is equal to (or later than) the end of a first symbol of the RFID tag response, and that is equal to (or earlier than) the start of a second symbol of the RFID tag response.

The RFID reader can perform the channel hopping to switch between a configured plurality of different carrier frequencies for a PBR-based ranging or distance estimation corresponding to the range or distance between the RFID reader and an RFID tag. In one illustrative example, the RFID reader can channel hop between the plurality of different carrier frequencies within a single message (e.g., a single command) transmitted between the RFID reader and the RFID tag. Based on performing the channel hopping within a single message, the RFID reader can also determine a PBR-based distance estimate to the RFID tag using the single message (e.g., command).

In one illustrative example, the single message (e.g., command) used for the channel hopping and PBR-based distance estimation between the RFID reader and the RFID tag can be performed during a single pilot tone period. The single (e.g., one) pilot tone period can be a configured time period or time interval within which the RFID reader transmits a carrier wave to an RFID tag. In some examples, the single pilot tone period can be used to obtain the multiple phase change measurements for PBR-based distance estimation to the RFID tag, for example based on the channel hopping performed by the RFID reader during the single pilot tone period. In some examples, the single pilot tone period used by the RFID reader to perform PBR with channel hopping can correspond to a Query command transmitted from the RFID reader to an RFID tag.

Further aspects of the systems and techniques will be described with reference to the figures.

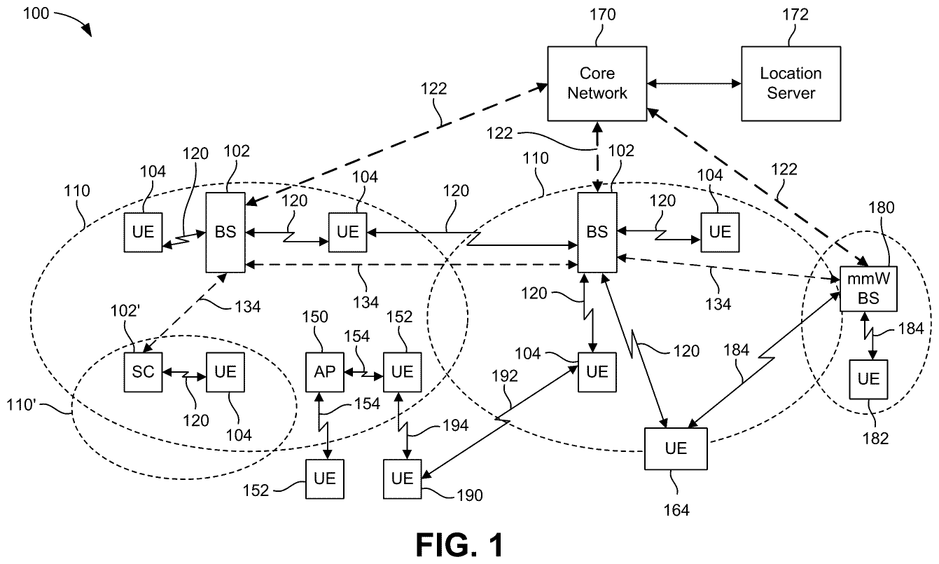

According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eIBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 102 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

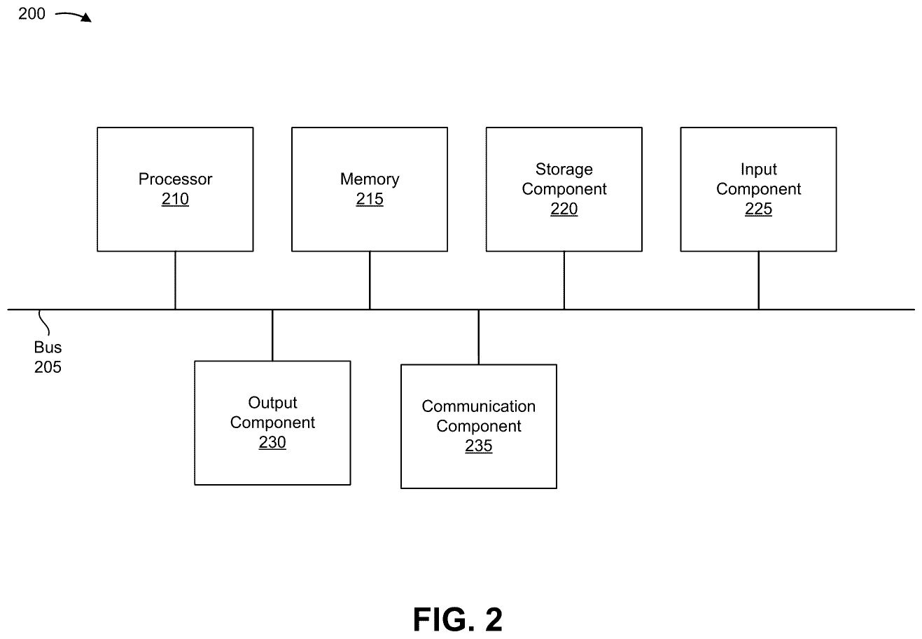

FIG. 2 is a diagram illustrating example components of a device 200, in accordance with the present disclosure. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

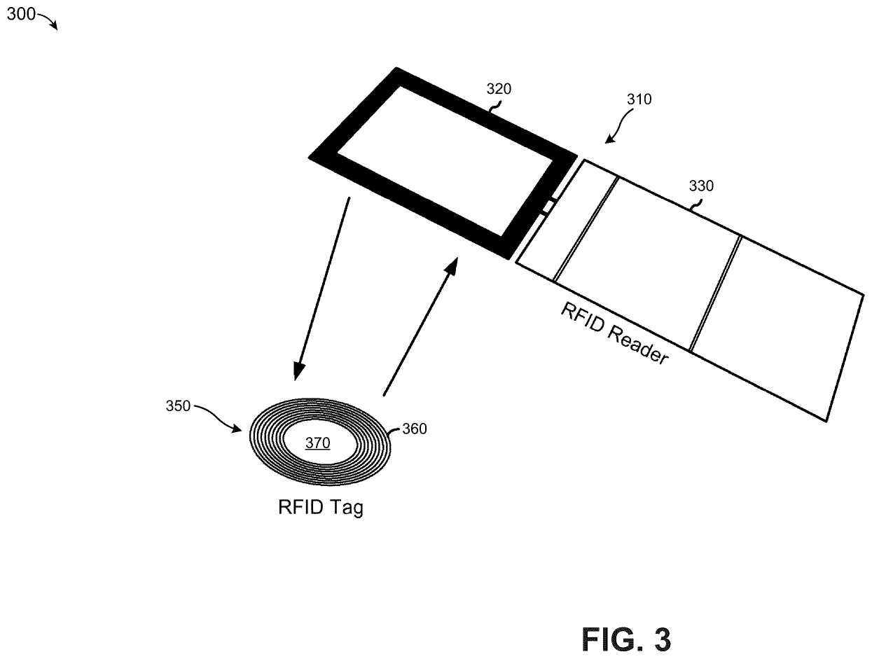

FIG. 3 is a diagram illustrating an example RFID system 300 that includes an RFID reader (e.g., energizer) 310 and an RFID tag 350. RFID reader 310 may also be referred to as an interrogator, a scanner, an energizer, etc. RFID tag 350 may also be referred to as an RFID label, an electronics label, etc.

RFID reader 310 includes an antenna 320 and an electronics unit 330. Antenna 320 radiates signals transmitted by RFID reader 310 and receives signals from RFID tags (e.g., such as the RFID tag 350) and/or other devices. Electronics unit 330 may include a transmitter and a receiver for reading RFID tags such as RFID tag 350. The same pair of transmitter and receiver (or another pair of transmitter and receiver) may support bi-directional communication with wireless networks, wireless devices, etc. In some examples, a first RFID reader or RFID device can include a transmitter for energizing one or more RFID tags, and a second RFID reader or RFID device can include a receiver for receiving the reflected signals from the one or more RFID tags. For instance, an RFID reader can be configured to implement energizing and tag reading capabilities (e.g., includes a transmitter and a receiver), can be configured to implement energizing capabilities (e.g., includes a transmitter), and/or can be configured to implement tag reading capabilities (e.g., includes a receiver). The electronics unit 330 may include processing circuitry (e.g., a processor) to perform processing for data being transmitted and received by RFID reader 310.

RFID tag 350 includes an antenna 360 and a data storage element 370. Antenna 360 radiates signals transmitted by RFID tag 350 and receives signals from RFID reader 310 and/or other devices. For instance, RFID tags can be passive, active, or semi-active. Passive RFID tags utilize the interrogating signal from an RFID reader to power a transmission by or from the RFID tag. Active and semi-active RFID tags can include a power source or battery, which can be used to power a transmission by or from the RFID tag. In some examples, the RFID tag 350 may be a passive RFID tag having no battery. In this case, a magnetic field from a signal transmitted by RFID reader 310 (e.g., an energizing or interrogating signal from the RFID reader 310) may induce an electrical current in RFID tag 350, which may then operate based on the induced current. RFID tag 350 can radiate its signal in response to receiving a signal from RFID reader 310 or some other device.

The RFID tag 350 can use the data storage element 370 to store identification information corresponding to the RFID tag 350 and/or corresponding to an item associated with the RFID tag 350 (e.g., an item to which the RFID tag 350 is attached, etc.). For example, data storage element 370 can be used to store identification information using various granularity levels for tracking and management of an RFID tagged item. An RFID tag attached to a respective item, or attached to a group of items, may store corresponding information thereof. For example, the RFID tag 350 can be configured to store, using data storage element 370, identification information corresponding to the item(s) to which the RFID tag 350 is attached and associated. For instance, RFID tag information can include one or more of a product name, a serial number, product information, a manufacturer, etc. In some examples, the RFID tag 350 can store (e.g., using the data storage element 370) identification information that is directly indicative of a tagged item, product, object, etc. For instance, the RFID tag 350 can store identification information such as a unique product serial number, etc. In some examples, the RFID tag 350 does not store product or item identification information directly, and stores a unique RFID tag serial number or identification number corresponding to the RFID tag 350, which may be externally mapped to various item identification information such as product serial numbers, product names, product SKUs, etc.

Data storage element 370 can be configured to store identification information for RFID tag 350, e.g., in an electrically erasable programmable read-only memory (EEPROM). RFID tag 350 may also include an electronics unit that can process the received signal and generate the signals to be transmitted.

RFID tag 350 may be read as follows. RFID reader 310 may be placed or moved within close proximity to RFID tag 350. RFID reader 310 may radiate a first signal (which is also called an interrogation signal) via its antenna 320. The energy of the first signal may be coupled from RFID reader antenna 320 to RFID tag antenna 360 via magnetic coupling and/or other phenomena. RFID tag 350 may receive the first signal from RFID reader 310 via antenna 360 and, in response, may radiate a second signal (which is also referred to as a responding signal) comprising the information stored in data storage element 370. RFID reader 310 may receive the second signal from RFID tag 350 via antenna 320 and may process the received signal to obtain the information sent in the second signal.

RFID system 300 may be designed to operate at various frequencies and/or frequency ranges. For example, RFID system 300 can operate at 900 MHz, within a range of 860-960 MHz, etc., among various other example frequencies and/or frequency ranges of RFID operations. RFID reader 310 may have a specified maximum transmit power level, which may be imposed by the Federal Communication Commission (FCC) in the United Stated or other regulatory bodies in other countries. The specified maximum transmit power level of RFID reader 310 limits the distance at which RFID tag 350 can be read by RFID reader 310.

As noted previously, the systems and techniques described herein can be used to perform PBR-based distance estimation to determine a distance between an RFID reader and an RFID tag, where the PBR-based distance estimation can be performed based on channel hopping performed within a single message or command (e.g., pilot tone signal, etc.) transmitted from the RFID reader to the RFID tag.

The RFID reader can perform the channel hopping to switch between a plurality of different carrier frequencies during the transmission of the tone signal to the RFID tag. The RFID tag can backscatter a modulated tone signal at each respective carrier frequency of the plurality of different carrier frequencies during the transmission from the RFID reader, and the RFID reader can determine a respective phase measurement (e.g., phase change measurement) and/or can determine relative phase information for each carrier frequency of the plurality of different carrier frequencies.

In some aspects, RFID communications can be performed between an RFID reader and one or more RFID tags of a plurality of RFID tags (e.g., RFID tags attached to corresponding items, also referred to as “RFID tagged items”). The RFID communications may include one or more RFID measurements such as phase-based ranging (PBR) measurements, Received Signal Strength Indicator (RSSI) measurements, and/or various combinations thereof.

PBR measurements can be performed between an RFID reader device and an RFID tag, where the RFID reader device is configured to transmit an energizing or interrogating signal and the RFID tag is configured to reflect the interrogating signal as a backscatter signal (e.g., also referred to as a “reflected signal” and/or “reply signal”).

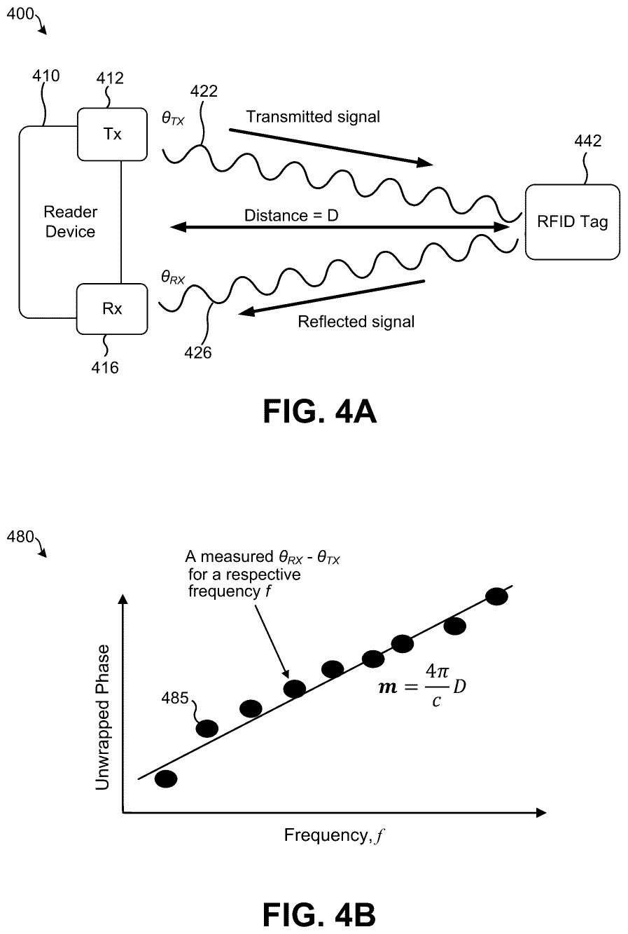

For example, FIG. 4A is a diagram illustrating an example of an RFID system 400 that can be used for phase-based ranging (PBR) and/or PBR-based distance estimation, in accordance with some examples. An RFID reader device 410 can include a transmitter (Tx) 412 and a receiver (Rx) 416, configured to transmit and receive RF signals, respectively. The RFID reader device 410 can use the transmitter 412 to transmit a transmitted signal 422 to an RFID tag 442. The transmitted signal 422 may be associated with a transmitted phase θ_{TX}. In some cases, the transmitted signal 422 may be a modulated signal, or may be an unmodulated signal (e.g., a carrier signal).

The transmitted signal 422, with phase θ_{TX}, propagates a distance D between the reader device 410 and the RFID tag 442, where the distance D is the separation distance or range between the reader device 410 and the RFID tag 442 (e.g., and where the distance D is relatively small such that propagation time does not have a significant effect on the measurement(s)). The RFID tag 442 can be a backscatter RFID tag configured to backscatter (e.g., reflect) an incident signal. For example, the RFID tag 442 can backscatter (e.g., reflect) the transmitted signal 422 as a reflected signal 426. The reflected signal can be associated with a phase θ_{RX} that may be different from the transmitted phase θ_{TX}. The reflected signal 426 is transmitted back to the RFID reader device 410, and is received by the receiver 416 of the RFID reader device 410, with the phase θ_{RX}. In some examples, the reflected signal 426 is weaker (e.g., lower power) than the transmitted signal 422. In some examples, the reader device 410 may generate the transmitted signal as a 900 megahertz (MHz) signal with phase θ_{TX}, among various other frequencies.

In one illustrative example, the RFID reader device 410 can perform phase-based ranging (PBR) measurements based on determining a phase difference between the transmitted signal 422 and the reflected signal 426. For example, a PBR measurement can correspond to the phase difference θ_{RX}−θ_{TX} between the transmitted signal 422 and reflected signal 426 (respectively) at the RFID reader device 410. In some aspects, the RFID reader device 410 determines the phase difference θ_{RX}−θTx based on removing the relatively strong transmitted signal 422 from the relatively weak reflected signal 426, which may introduce a source of phase error to both the phase difference measurement and the PBR measurement.

In some aspects, the carrier phase may change based on propagation distance at carrier frequency f_{c}, and distance D can be determined as:

$$D ≅ \frac{1}{2} \cdot \frac{{θ}_{RX} - {θ}_{TX}}{2 π} \cdot \frac{c}{{f}_{c}} \qquad Eq . ( 1 )$$

In some examples, a fixed calibration can be performed to account for antennas and reflection in the particular RFID tag 442. In some cases, the maximum range value that can be accurately and/or reliably determined using Eq. (1) can be based on the carrier frequency f_{c}. For example, the frequency f_{c} and the wavelength A may vary inversely with one another, and PBR performed according to Eq. (1) may be associated with a maximum range (e.g., a maximum value of D) of λ/2, etc.

In some cases, a plurality of PBR measurements can be performed between the RFID reader device 410 and each RFID tag 442 that is of interest or within range of the transmitted signal 422. In one illustrative example, a plurality of transmitted signals 422 can be generated and transmitted by the RFID reader device 410, where each transmitted signal uses a different frequency. A phase difference measurement can be determined for each pair of transmitted signal at a particular frequency and the corresponding reflected signal.

For example, FIG. 4B is a diagram illustrating a plot 480 of PBR-based distance estimation using a plurality of RFID phase measurements 485, in accordance with some examples. For example, each RFID phase measurement 485 can be a phase difference measurement, such as the phase difference measurement θ_{RX}−θ_{TX} between the transmitted signal 422 and reflected signal 426 of FIG. 4A for a particular frequency f_{c}.

In some aspects, each RFID phase measurement 485 can be a phase difference (e.g., relative phase information, etc.) measured between a transmitted signal at a respective carrier frequency f_{c}, and a corresponding reflected signal (e.g., a reflection or backscatter modulation of the transmitted signal, by an RFID tag). Each RFID phase measurement 485 of the plurality of RFID phase measurements 485 of FIG. 4B can correspond to signals between an RFID reader and particular RFID tag, such as the RFID reader device 410 and RFID tag 442 of FIG. 4A. In some cases, each phase difference 485 can be determined for a transmitted signal (e.g., RF carrier transmitted by the RFID reader) having a carrier frequency f_{c} that is a configured offset fₛ away from the adjacent phase difference measurements 485 made at (f_{c}+fₛ) and (f_{c}−fₛ).

In one illustrative example, PBR measurements can be performed to obtain the plurality of phase differences 485 using a plurality of different transmitted signal carrier frequencies f_{c} for the transmitted signal 422 from the RFID reader device 410 of FIG. 4A. A PBR-based distance estimate can be determined based on the gradient (e.g., slope) of a best-fit line determined for the plurality of phase difference measurements 485. For example, the gradient m can be determined as:

$$m = \frac{4 π}{c} D \qquad Eq . ( 2 )$$

Here, D represents the PBR-based distance estimate between the RFID reader device 410 and the RFID tag 442. The term c represents the speed of light (e.g., which is the speed with which the RF signals travel or propagate between the RFID reader and RFID tag).

In some examples, a variance of the estimated distance D can be determined as

$${σ}_{D}^{2} ,$$

where

$${σ}_{D}^{2}$$

is based on the gradient-error equation of the best-fit line for the gradient m, the phase noise variance

$${σ}_{ϵ}^{2} ,$$

the frequency spacing fₛ, and the number of uniformly-spaced samples Nin the plurality of phase difference measurements 485:

$${σ}_{D}^{2} = \frac{3 {σ}_{ϵ}^{2} {c}^{2}}{4 {π}^{2} {f}_{s}^{2} ( {N}^{3} - N )} \qquad Eq . ( 3 )$$

The term σ_{∈} represents the total phase noise, which can comprise principal components:

$${σ}_{ϵ}^{2} = {σ}_{ϵ G}^{2} + {σ}_{ϵ V}^{2} .$$

For example,

$${σ}_{ϵ V}^{2}$$

can represent the phase noise variance due to the VCO oscillator, and may be a function of the reader radio (e.g., the RFID reader device 410 radio, such as Rx 416 and/or Tx 412) and any additional phase noise introduced by the tag (e.g., the RFID tag 442) and the signal cancellation.

The term

$${σ}_{ϵ G}^{2}$$

can represent the phase noise variance based on Gaussian noise. For example, for SNR_{dB} 10>dB, the Gaussian noise (e.g., SNR) can create an approximate phase noise σ_{∈G} according to:

$${σ}_{ϵ G} ≅ \sqrt{\frac{1}{2 \cdot SNR}} , where SNR = {10}^{\frac{{SNR}_{d B}}{10}} \qquad Eq . ( 4 )$$

In some aspects, based on averaging multiple samples N (e.g., multiple phase difference measurements, such as the plurality of phase difference measurements 485 of FIG. 4B), the Gaussian phase noise σ_{∈G} of Eq. (4) can be reduced. Reducing the Gaussian phase noise σ_{∈G} can reduce the variance of the PBR-based distance estimate D, with the variance given according to Eq. (3).

For example, in some aspects, PBR distance estimation can be performed based on analyzing the phase change in an RF carrier, where the phase change in the RF carrier is based on the distance between two radio antennas. The phase change of the RF carrier can be analyzed to measure and/or determine range. In one illustrative example, multiple phase measurements (e.g., phase difference measurements 485 of FIG. 4B) can be obtained, each at different respective carrier frequencies f_{c}.

The gradient, m, of a best-fit line through the unwrapped phases, against carrier frequency f_{c}, can be used as an approximation to the distance D between the radios (e.g., between the RFID reader device 410 and the RFID tag 442 of FIG. 4A). For example, in the context of RFID, PBR distance estimation can be used to determine the distance (e.g., range) between an RFID reader device and a particular RFID tag. A single phase change can be measured by the RFID reader device, for example on a single carrier, by transmitting an RF carrier, with the RFID tag configured to backscatter the carrier modulated with a modulated tone (e.g., 1010101010, etc.). For instance, transmitting an RF carrier can correspond to the transmitted signal 422 transmitted by the RFID reader device 410 of FIG. 4A. The RFID tag backscattering the carrier modulated with a modulated tone can correspond to the reflected signal 426 from the RFID tag 442 of FIG. 4A.

For example, in RFID RAIN (e.g., Radio Frequency Identification Recognize, Action, Interact, Network), the transmitted signal 422 and reflected signal 426 can be implemented based on an RFID tag (e.g., the RFID tag 442 of FIG. 4A) responding to a Query command (e.g., transmitted by the RFID reader device 410 of FIG. 4A). In some examples, the RFID reader device 410 (e.g., and Rx 416 thereof) can measure a single phase-difference from the modulated tone signal on either side of the DC carrier, to obtain an individual phase difference 485 for a corresponding carrier frequency f_{c}.

The distance estimate D can be determined based on multiple phase difference measurements 485, as noted above. In some cases, multiple commands can be transmitted from the RFID reader device 410 to the RFID tag 442 (e.g., multiple Query transmissions). In some cases, a separate Query command (e.g., a separate transmitted signal 422) can be used for each phase difference measurement 485 at a corresponding carrier frequency f_{c}. In some examples, the RFID reader device 410 can be configured to change the carrier frequency f_{c} of the transmitted signal 422 during the reading back of the modulated tone of the reflected signal 426 from the RFID tag 442. For instance, in examples where the RFID tag 442 is a passive RFID tag, the RFID tag 442 is not aware of the change in carrier frequency f_{c} and will continue to reflect the modulated tone with the newly adjusted RF carrier.

In one illustrative example, the RFID reader device 410 can be configured to capture the reflected signal 426 from the RFID tag 442 that is responsive to the changing carrier frequency and/or RF carrier used for the transmitted signal 422. Based on storing information indicative of the respective time(s) when the RFID reader device 410 changed the carrier frequency for the transmitted signal 422, the RFID reader device 410 can be configured to extract or determine the relative phase difference information 485 for each frequency of interest associated with plotting the plurality of measurements 485 along the horizontal frequency axis of the plot 480 of FIG. 4B. In one illustrative example, the systems and techniques can be used to determine the distance estimate D using a single message (e.g., transmitted signal 422, Query message with changing RF carrier, etc.) from the RFID reader device 410 to the RFID tag 442.

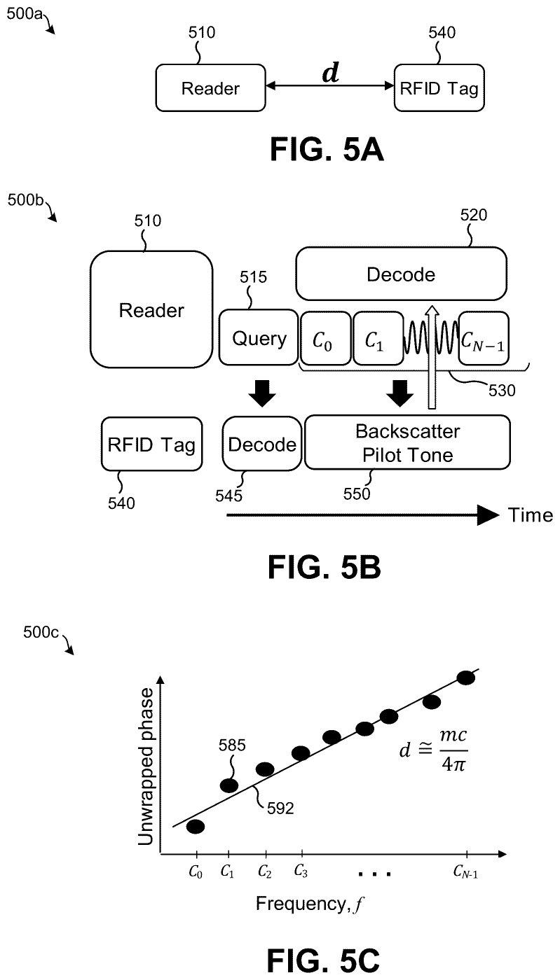

FIG. 5A is a diagram illustrating an example RFID system 500a including an RFID reader device 510 and an RFID tag 540 associated with an example RFID ranging measurement that can be used to determine the distance d between the RFID reader 510 and the RFID tag 540, in accordance with some examples. In some examples, the RFID reader device 510 of FIG. 5A can be the same as or similar to the RFID reader device 410 of FIG. 4A, and the RFID tag 540 of FIG. 5A can be the same as or similar to the RFID tag 442 of FIG. 4A.

FIG. 5B is a diagram illustrating an example of RFID communications 500b between the RFID reader device 510 and the RFID tag 520 of FIG. 5A. In one illustrative example, the RFID communications 500b can correspond to an example where the RFID tag 540 backscatters a pilot tone 550 transmitted by the RFID reader device 510. In some aspects, to perform PBR-based distance estimation between the RFID reader 510 and the RFID tag 540, the RFID reader 510 can be configured to use a single message or command transmitted to the RFID tag 540 using channel hopping on and/or between a plurality of different carrier frequencies.

In one illustrative example, the single message (e.g., command) used for the channel hopping and PBR-based distance estimation between the RFID reader 510 and the RFID tag 540 can be performed during a single pilot tone period. For example, the single pilot tone period can be one transmission period during which the RFID reader 510 transmits the pilot tone signal 550 to the RFID tag 540.

In some cases, the single pilot tone period (e.g., associated with the pilot tone signal 550) can correspond to and/or can be configured based on a Query command 515 that is previously transmitted from the RFID reader 510 to the RFID tag 540. For example, the RFID reader 510 can transmit the Query command 515 to the RFID tag 540, and the RFID tag 540 can be configured to decode 545 the Query command 515.

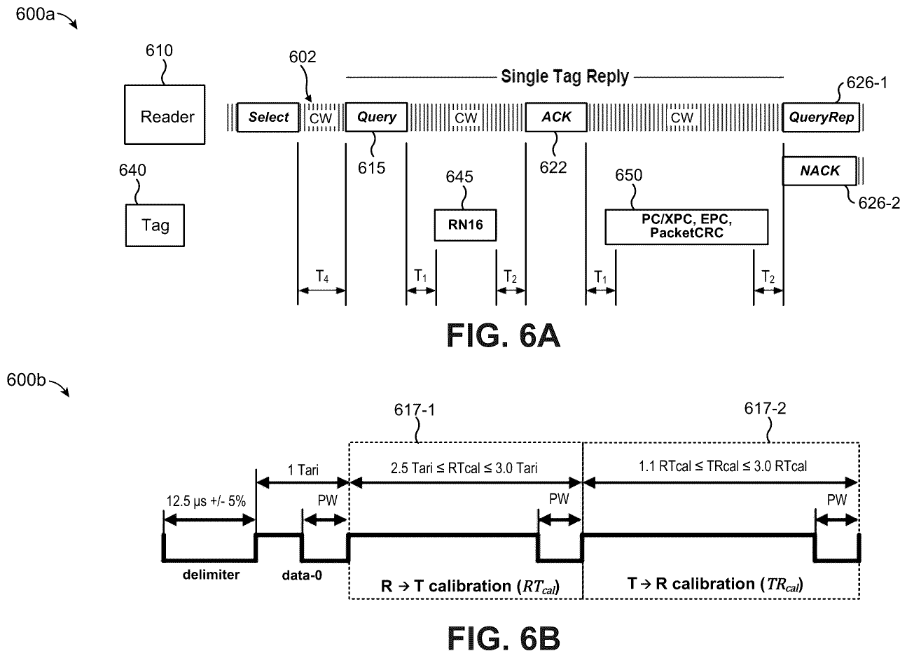

The RFID tag 540 can subsequently perform backscattering and modulation of the pilot tone signal 550 based at least in part on the decoded information of the Query command 515. An example of a Query command (e.g., also referred to as a Query message) transmitted from an RFID reader to an RFID tag is shown as the Query 615 of FIG. 6A and the Query 600b of FIG. 6B. In some aspects, the Query command 515 of FIG. 5B can be the same as or similar to the Query 615 of FIG. 6A and/or the Query 600b of FIG. 6B.

The RFID protocol provides a process in which an RFID tag (e.g., RFID tag 540) is configured to decode and respond to a Query command (e.g., Query command 515) from an RFID reader (e.g., RFID reader 510). For example, the RFID tag 540 can decode 545 and respond (e.g., by backscattering the pilot tone 550) to the Query command 515 based at least in part on the process specified by the RFID protocol for Tag responses to a Query command. In some cases, the pilot tone 550 from the RFID reader 510 can be an extended pilot tone signal. The extended pilot tone signal 550 can be backscattered by the RFID tag 540 using a repeating 101010 sequence (e.g., modulated on to a carrier wave comprising the extended pilot tone signal 550). The repeating 101010 sequence modulated onto the backscattered pilot tone signal 550 by the RFID tag 540 can be used for frequency calibration in the RFID protocol. The RFID reader 510 can be configured to decode 520 the backscattered pilot tone 550 modulated signal from the RFID tag 540. For example, the frequency calibration of the RFID protocol can be performed based on the RFID reader 510 performing decoding 520 of the backscatter pilot tone 550.

In one illustrative example, the systems and techniques can be configured to utilize the extended pilot tone signal 550 (e.g., associated with the frequency calibration in the RFID protocol) to measure and/or determine a plurality of phase measurements at multiple different carrier frequencies within a single pilot tone period. The single (e.g., one) pilot tone period can be a configured time period or time interval within which the RFID reader 510 transmits a carrier wave to the RFID tag 540. For example, the single pilot tone period can be the time period or length (e.g., time duration) of the pilot tone signal 550.

As noted above, the process provided by the RFID protocol for Tag responses to a Query command configures the RFID reader 510 to remain tuned to a single carrier frequency for the duration of the pilot tone 550 (e.g., the same carrier frequency is used for the entire pilot tone period associated with transmission of the extended pilot tone 550). In some aspects, the systems and techniques described herein can be used to perform PBR-based distance estimation to determine the distance d between the RFID reader 510 and the RFID tag 540 using channel hopping to cause the RFID reader 510 to switch between a plurality of different carrier frequencies 530 within the single pilot tone period corresponding to the extended pilot tone 550.

For example, the RFID reader 510 can change the carrier frequency a configured number of times N during the single pilot tone period corresponding to the pilot tone signal 550, to thereby perform channel hopping between the N different carrier frequencies 530 (e.g., channels) C₀, C₁, . . . , C_{N-1}. In some aspects, the RFID reader 510 can change between the plurality of carrier frequencies 530 during reading back of the backscattered modulated tone reflected from the RFID tag 540 to the RFID reader 510 (e.g., during readback of the backscattered and modulated pilot tone signal 550 reflected by the RFID tag 540).

In examples where the RFID tag 540 is a passive RFID tag, the RFID tag 540 is unaware (e.g., does not know) that the RF carrier of the pilot tone signal 550 has changed in frequency. For example, the RFID tag 540 may be unaware of the change in RF carrier 530 of the pilot tone signal 550 from C₀ to C₁, from C₁ to C₂, . . . , from C_{N-2} to C_{N-1}, etc. Because the passive RFID tag 540 is unaware of the RF carrier of the pilot tone signal 550 changing in frequency, the RFID tag 540 will continue to reflect the modulated pilot tone signal 550 using each newly adjusted RF carrier. For example, the RFID tag 540 can continuously reflect the modulated pilot tone signal 550 at each of the N different carrier frequencies C₀, C₁, . . . , C_{N-1} included in the plurality of carrier frequencies 530 used to perform channel hopping by the RFID reader 510.

The RFID reader 510 can receive the reflected (e.g., backscattered) pilot tone signal 550 from the RFID tag 540 over the pilot tone signal period. The RFID reader 510 can use channel hopping timing information (e.g., associated with switching between the plurality of carrier frequencies 530) to determine relative phase information for each of the N different carrier frequencies C₀, C₁, . . . , C_{N-1} included in the plurality of carrier frequencies 530. The RFID reader 510 can be configured to use the relative phase information determined for each respective carrier frequency C₀, C₁, . . . , C_{N-1} 530 to determine a PBR-based distance estimation of the distance d between the RFID reader 510 and the RFID tag 540, using a single message and single pilot tone period (e.g., the single Query message 515 and the single pilot tone period of the pilot tone signal 550).

For example, the relative phase information determined by the RFID reader 510 based on the backscattered pilot tone signal 550 corresponding to each respective carrier frequency C₀, C₁, . . . , C_{N-1} 530 can be phase change information indicative of the difference between the carrier frequency 530 transmitted by the RFID reader 510 and the backscatter carrier frequency received by the RFID reader 510 from the RFID tag 540.

In one illustrative example, the relative phase information (e.g., phase change) measured by the RFID reader 510 for a particular carrier frequency C₀, C₁, . . . , C_{N-1} 530 can correspond to a respective one of the phase measurements 585 shown in the PBR distance estimation graph 500c of FIG. 5C. For example, FIG. 5C is a diagram illustrating an example of PBR-based distance estimation 500c using a plurality of RFID phase measurements 585 obtained based on the RFID communications of FIG. 5B, in accordance with some examples.

The PBR distance estimation graph 500c of FIG. 5C is the same as the PBR distance estimation graph 480 of FIG. 4B, with the addition of the corresponding carrier frequency labels (e.g., C₀, C₁, C₂, C₃, . . . , C_{N-1}) along the horizontal frequency axis in FIG. 5C. In some aspects, the portion of the backscattered pilot tone signal 550 received by the RFID reader 510 for the first carrier frequency C₀ of FIG. 5B can be used to determine the first relative phase measurement corresponding to the C₀ measurement data point in the graph 500c of FIG. 5C.

The portion of the backscattered pilot tone signal 550 received by the RFID reader 510 for the second carrier frequency C₁ of FIG. 5B can be used to determine the second relative phase measurement corresponding to the C₁ measurement data point of the graph 500c of FIG. 5C, etc. The portion of the backscattered pilot tone signal 550 received by the RFID reader 510 for the N^{th} carrier frequency C_{N-1} of FIG. 5B can be used to determine the N^{th} relative phase measurement corresponding to the C_{N-1} measurement data point of the graph 500c of FIG. 5C.

In one illustrative example, the RFID reader 510 can be configured to determine the distance d between the RFID reader 510 and the RFID tag 540 as the gradient m of a best fit line 592 determined for the plurality of phase measurements 585 obtained for each respective carrier frequency C₀, C₁, . . . , C_{N-1} of the plurality of carrier frequencies 530 used for the channel hopping within the single pilot tone signal 550 period. In some aspects, the RFID reader 510 is configured to determine the PBR-based distance estimate d to the RFID tag 540 based on performing a plurality (e.g., N) of phase measurements 585 during the single pilot tone 550. From the plurality of phase measurements 585 obtained during the single pilot tone 550 time period, the RFID reader 510 can determine a single range estimate

$$d ≅ \frac{m c}{4 π}$$

corresponding to the distance (e.g., range) between the RFID reader 510 and the RFID tag 540).

FIG. 6A is an example link timing diagram 600a depicting link timing associated with RFID communications between an RFID reader device 610 and an RFID tag 640, in accordance with some examples. In some aspects, the RFID reader 610 can be the same as or similar to the RFID reader 410 of FIG. 4A, the RFID reader 510 of FIGS. 5A and 5B, etc. The RFID tag 640 can be the same as or similar to the RFID tag 442 of FIG. 4A, the RFID tag 540 of FIGS. 5A and 5B, etc.

The link timing diagram 600a corresponds to a Query command 615 transmitted by the RFID reader 610 and received by the RFID tag 640. The Query command 615 (and other RFID communications between the RFID reader 610 and the RFID tag 640) can be performed based on a carrier wave (CW) 602 that is transmitted by the RFID reader 610 and backscattered as a modulated reflection by the RFID tag 640. In some examples, the Query command 615 of FIG. 6A can be the same as or similar to the Query command 515 of FIG. 5B.

The RFID link timing diagram 600a includes a ‘Select’ command, which can be used by the RFID reader 610 to select a subset of one or more RFID tags (e.g., RFID tag 640) included in a plurality of RFID tags that are selectable or known to the RFID reader 610. The CW 602 represents a continuous RF signal (e.g., a continuous wave) emitted by the RFID reader 610 and used to perform the backscatter communications by the RFID tag 540.

The Query command 615 can be transmitted from the RFID reader 610 to the RFID tag(s) identified in the ‘Select’ command, using the CW 602.

Based on receiving and decoding the Query command 615 from the RFID reader 610, the RFID tag 640 can reply with an RN16 message 645 with a 16-bit random number. The RN16 message 645 can be transmitted by the RFID tag 540 based on backscattering and modulating the CW 602 from the RFID reader 610.

The RFID reader 610 can acknowledge receipt of the RN16 message 645 using a subsequent ACK 622 to the RFID tag 640. In some examples, the RFID tag 640 can receive the ACK 622 and can transmit an additional message 650 to the RFID reader 610. For example, the additional message 650 after the ACK 622 can be indicative of or can include one or more Protocol Control (PC) bits, Extended Protocol Control (XPC) bits, an Electronic Product Code (EPC) of the RFID tag 640, a packet cyclic redundancy check (CRC), and/or other data, etc. Where the RN16 message 645 comprises a 16-bit random number and is used to establish the communications between the RFID reader 610 and the RFID tag 640, the additional data message 650 can be indicative of the unique identifier or other stored information and/or data associated with the RFID tag 640. For example, the additional data message 650 can indicate and/or include the unique identifier of the RFID tag 640 as PC or EPC bits, etc.

After receiving the additional data message 650 from the RFID tag 640, the RFID reader 610 may respond with a QueryReply 626-1 or other command if the EPC indicated in the additional data message 650 is valid. In some cases, the RFID reader 610 may respond to the additional data message 650 with a negative ACK (NACK) 626-2 if the EPC indicated in the additional data message 650 is invalid.

The RFID link timing diagram 600a includes the timing intervals T₁, T₂, and T₄. The first time interval T₁ corresponds to the time interval between the end of the RFID reader 610's command and the start of the RFID tag 640's response.

The time interval T₂ corresponds to the time between the end of the RFID tag 640's response and the start of the RFID reader 610's next command. The time interval T₄ corresponds to the initial time interval after the “Select” command during which the RFID reader 610 emits the CW 602 before issuing the Query command 615.

In some aspects, the time interval T₁ can be referred to as a “TR” waiting time or a “TR” wait time. For example, the TR waiting time can correspond to the waiting time for a packet from the RFID tag 640 (e.g., T) to the RFID reader 610 (e.g., R), given as the time interval between the end of the RFID reader 610's command and the beginning of the RFID tag 640's response.

The value of T₁ may be based on device characteristics and/or device capabilities of one or both of the RFID reader 610 and/or the RFID tag 640. For example, the value of T₁ can be based at least in part on the decode time for the RFID tag 640 to decode the command received from the RFID reader 610, the processing time for the RFID tag 640 to generate and/or modulate the corresponding response message onto the CW 602, etc. The value of T₁ can additionally be based at least in part on the respective internal clocks of the RFID reader 610 and/or the RFID tag 640, and/or can be based at least in part on other variations or differences in timing synchronization between the RFID reader 6t10 and the RFID tag 640.

In some cases, the TR waiting time T₁ can vary between different RFID reader command-RFID tag response pairs. For example, the TR waiting time T₁ between the Query command 615 and the RN16 message 645 can have a first value, and the TR waiting time T₁ between the ACK 622 and the additional data message 650 can have a second value different from the first value.

Based on variation in the TR waiting time T₁ for each pair of command and response messages between the RFID reader 610 and the RFID tag 640, the arrival time of a tag-to-reader packet may generally be unknown to the RFID reader 610. In some aspects, the main uncertainty in the arrival time of a tag-to-reader (TR) packet can be based on estimation error of time parameters in the tag processing associated with the RFID tag 640.

For example, the estimation error of time parameters can be an estimation error associated with a reader-to-tag (RT) calibration time parameter RT_{cal} and/or an estimation error associated with a tag-to-reader (TR) calibration time parameter TR_{cal}. The calibration time parameters RT_{cal} and TR_{cal} can be indicated and/or configured within an RT preamble of a command or other message transmitted from the RFID reader 610 to the RFID tag 640.

FIG. 6B is a diagram illustrating an example reader-to-tag (RT) preamble 600b that can be included in a message (e.g., Query command 615 of FIG. 6A, etc.) transmitted from the RFID reader device 610 to the RFID tag 640, in accordance with some examples.

The “delimiter” portion of the transmission can have a fixed duration of 12.5 μs±5%, and can be used to indicate the beginning of a communication session and/or can be used to assist in the RFID tag 640 synchronizing with the signal from the RFID reader 610. In some cases, the delimiter signal duration can assist the RFID tag 640 in differentiating the delimiter from other signals and to synchronize its internal clock.

The “data-0” portion of the transmission can represent data information (e.g., a data-0 bit, etc.) and can be associated with a time duration of 1 Tₐᵣᵢ, where Tₐᵣᵢ is the unit interval or reference time (e.g., also referred to as the “reference time interval”). The data-0 bit can be represented by a pulse followed by a pulse with a pulse width PW.

The RT preamble 600b can further include an RT calibration signal (e.g., RT_{cal}) 617-1 and a TR calibration signal (e.g., TR_{cal}) 617-2 used for timing calibration between the RFID reader 610 and RFID tag 640, and vice versa.

The RT calibration signal RT_{cal} 617-1 can be used as a calibration signal for the RFID tag 640. For example, an RFID tag can be configured to use an RT calibration signal (e.g., such as the RT calibration signal RT_{cal} 617-1) to determine a detection threshold corresponding to a data-0 and/or data-1 portion of a transmission received by the RFID tag. In some cases, the RT calibration signal can be used by the RFID tag to determine the detection threshold of data-0 and data-1 when the RFID tag performs demodulation of data information transmitted by an RFID reader device. For example, the duration of RT calibration signal RT_{cal} 617-1 can be selected to be between 2.5 Tₐᵣᵢ and 3.0 Tₐᵣᵢ, (e.g., between 2.5 to 3.0 times the Tₐᵣᵢ reference time interval), and is used as a reference for the RFID tag 640's timing adjustments.

The TR calibration signal TR_{cal} 617-2 can be used as a calibration signal for the RFID reader 610 to adjust its backscatter link frequency (BLF) based on the response characteristics of the RFID tag 640. The duration of the TR calibration interval TR_{cal} 617-2 can range from 1.1 to 3.0 times the RT_{cal} interval 617-1, and may be adjusted to ensure the RFID reader 610 can accurately decode signals from the RFID tag 640.

In some aspects, the uncertainty associated with the arrival time of a TR packet (e.g., associated with estimation error of the time parameters RT_{cal} 617-1 and TR_{cal} 617-2 indicated in the RT preamble 600b, etc.) can be estimated by the RFID reader 610 during RN16 reception. For example, the time uncertainty of the arrival time of a TR packet can be estimated by the RFID reader 610 during reception of the RN16 response message 645 backscattered by the RFID tag 640 and received by the RFID reader 610.

The uncertainty can be estimated as the BLF error FrT associated with the timing derivation used by the RFID tag 640 when transmitting the RN16 message 645. The RN16 message 645 is the first response transmitted by the RFID tag 640 after the initial Query command 615 from the RFID reader 610. In one illustrative example, the estimated error or uncertainty FrT for the derived timing information used by the RFID tag 640 can be determined from the first response received by the RFID reader 610 from the RFID tag 640 (e.g., the RN16 message 645), and may subsequently be used by the RFID reader 610 to predict a TR packet arrival time in a subsequent EPC packet or additional data message 650 transmitted from the RFID tag 640 to the RFID reader 610.

For example, in some aspects, the TR waiting time T₁ associated with the wait to receive a TR packet from the RFID tag 640 can be bounded by max(RT_{cal}, 10Tₚᵣᵢ)*(1−|FrT|)−2u≤T₁≤max(RT_{cal},10Tₚᵣᵢ)*(1+|FrT|)±2 us.

Based on the predicted packet arrival time of the subsequent EPC packet of the additional message 650 from the RFID tag 640, the RFID reader 610 can be configured to apply and/or perform frequency hopping (e.g., channel hopping) during the EPC preamble portion (e.g., pilot and preamble) of the additional message 650 to obtain the plurality of phase measurements (e.g., 585 of FIG. 5C) for the PBR-based distance estimation of the distance d between the RFID reader 610 and the RFID tag 640.

In one illustrative example, the systems and techniques can be configured to perform the frequency hopping for the PBR-based distance estimation to align each frequency hop (e.g., each change or switch from a current carrier frequency of the plurality of carrier frequencies C₀, C₁, . . . , C_{N-1} to the next carrier frequency of the plurality) with a symbol boundary between consecutive TR symbols of the backscattered modulated tag-to-reader response message transmitted from the RFID tag 640 to the RFID reader 610.

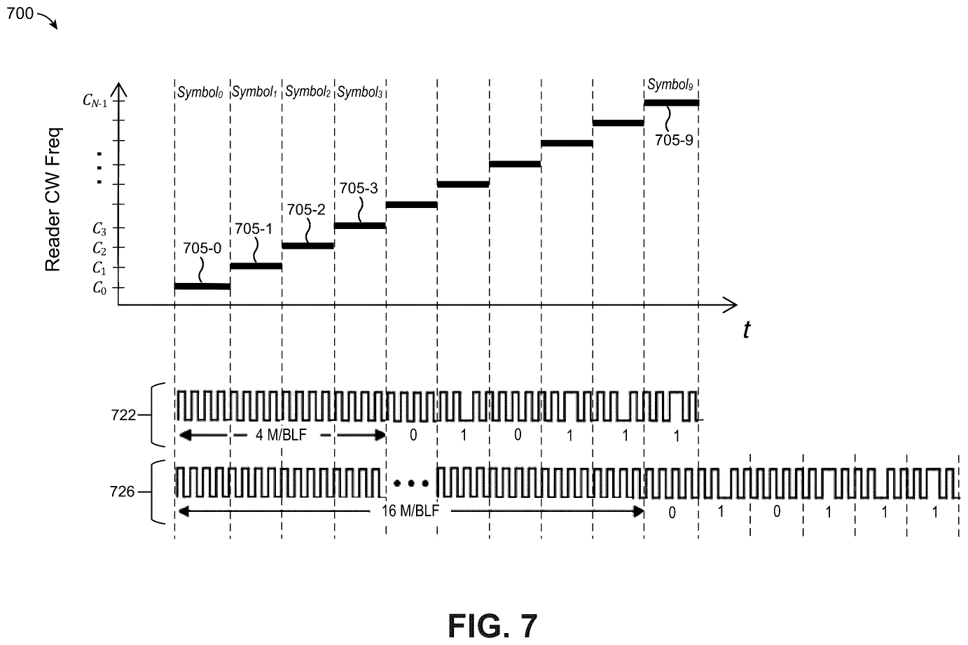

For example, FIG. 7 is a diagram illustrating an example of frequency hopping 700 performed by an RFID reader device (e.g., such as the RFID reader 410 of FIG. 4A, the RFID reader 510 of FIGS. 5A-B, the RFID reader 610 of FIG. 6A, etc.). The frequency hopping 700 can be performed to switch (e.g., hop) between a plurality of different carrier frequencies C₀, C₁, . . . , C_{N-1} which may be the same as or similar to the plurality of carrier frequencies 530 of FIGS. 5B and 5C.

In one illustrative example, the frequency hopping 700 configuration can be implemented based on each frequency hop between two carrier frequencies being aligned with a symbol boundary between consecutive TR preamble symbols of the backscatter signal from the RFID tag. For example, the RFID reader device can transmit the carrier wave CW 602 of FIG. 6A using a first frequency C₀ for the time 705-0, before performing a frequency hop to transmit using a second frequency C₀ for the time 705-1.

In some aspects, the time duration 705-0 of the C₀ carrier frequency emitted by the RFID reader is aligned with a Symbol₀ of the TR preamble backscattered by the RFID tag in response to the C₀ carrier frequency; the time period 705-1 of the C₁ carrier frequency emitted by the RFID reader is aligned with a Symbol₁ of the TR preamble backscattered by the RFID tag in response to the C₁ carrier frequency; the time period 705-2 of the C₂ carrier frequency emitted by the RFID reader is aligned with a Symbol₂ of the TR preamble backscattered by the RFID tag in response to the C₂ carrier frequency; the time period 705-3 of the C₃ carrier frequency emitted by the RFID reader is aligned with a Symbol₃ of the TR preamble backscattered by the RFID tag in response to the C₃ carrier frequency; . . . ; and the time period 705-9 of the C₉ carrier frequency emitted by the RFID reader is aligned with a Symbol₉ of the TR preamble backscattered by the RFID tag in response to the C₉ carrier frequency.

In one illustrative example, the systems and techniques can be configured to align the frequency hopping configuration 700 of the RFID reader carrier wave with the TR preamble symbol boundaries of a plurality of TR preamble symbols included in the RFID tag response message to the RFID reader.

For example, all packets transmitted from an RFID tag to an RFID reader (e.g., tag-to-reader, or TR packets) may start with a TR preamble that includes a plurality of TR symbols. In some aspects, a default TR preamble length can be 10 symbols. For example, a first example TR preamble 722 is illustrated in FIG. 7 and includes 10 TR preamble symbols. In some examples, an extended TR preamble length can be 22 symbols. For instance, a second example TR preamble 726 is illustrated in FIG. 7 and includes 22 TR preamble symbols.

The first TR preamble 722 and the second TR preamble 726 are both aligned with the frequency hops between the respective carrier frequencies C₀, C₁, . . . , C_{N-1} implemented in the frequency hopping configuration 700. For example, FIG. 7 illustrates the TR preamble symbol boundaries between consecutive symbols of the TR preambles 722, 726 as the vertical dashed lines indicating Symbol₀, Symbol₁, Symbol₂, Symbol₃, . . . , Symbol₉.

The TR preamble symbol boundaries can be aligned with each frequency hop between the respective carrier frequencies C₀, C₁, . . . , C_{N-1} implemented in the frequency hopping configuration 700, based on the RFID reader device determining frequency hop timing information using the estimated timing uncertainty FrT determined by the RFID reader based on the initial message from the RFID tag (e.g., the RN16 message 645 sent by the RFID tag 640 in response to the Query command 615 from the RFID reader 610 of FIG. 6A).

In some aspects, the RFID reader device can use the estimated timing uncertainty determined for a first message received by the RFID reader from an RFID tag, to predict a packet arrival time for a subsequent message received by the RFID reader from the same RFID tag and/or from the same RFID tag within the same communication period or signal tone period.

By accurately predicting the adjusted packet arrival time based on the previously measured error or uncertainty in the RFID tag's timing, the RFID reader can align the frequency hopping pattern with the symbol boundaries of the TR preamble included at the start of the subsequent message from the RFID tag.

In some examples, frequency hopping can be applied in a digital rotator of the RFID reader that aligns to the TR preamble symbols of either one of a first (e.g., default) TR preamble length such as the 10-symbol TR preamble 722, and a second (e.g., extended) TR preamble length such as the 22-symbol TR preamble 726.

In some cases, the number of hops implemented in the frequency hopping pattern 700 by the RFID reader can determine the total bandwidth of the phase measurements for the PBR-based distance estimation performed by the RFID reader. The total bandwidth of phase measurements can correspond to the accuracy of the PBR-based distance estimation of the distance d from the RFID reader to the RFID tag. In some examples, the RFID reader can increase the accuracy of the PBR-based distance estimate of d by implementing the frequency hopping pattern 700 using a greater number of frequency hops (given a fixed hop size). In some aspects, when higher accuracy is needed or desired for the PBR-based distance estimate d from the RFID reader to the RFID tag, the RFID reader can enable the extended length TR preamble. For example, the RFID reader can increase the accuracy of the PBR-based distance estimate d by configuring the RFID tag with TRext, corresponding to the RFID tag starting each of its TR messages to the RFID reader using the extended length, 22-symbol TR preamble 726, etc.

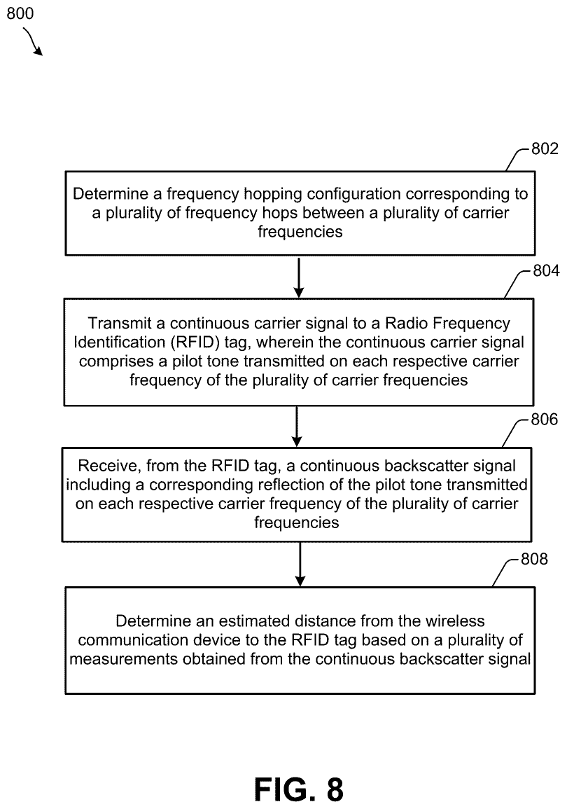

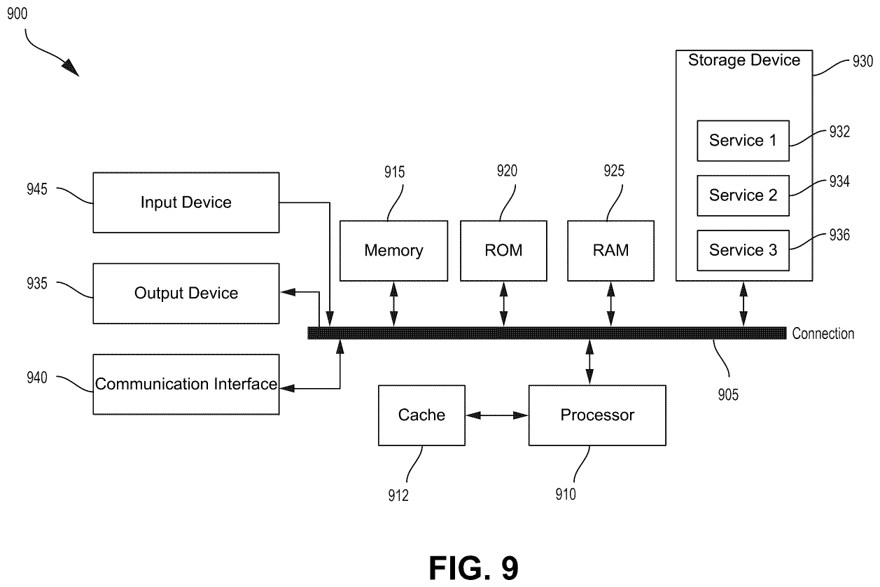

FIG. 8 is a flowchart diagram illustrating an example of a process 800 for wireless communications. In some examples, the process 800 can be performed by a computing device or apparatus or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the computing device or apparatus. The operations of the process 800 may be implemented as software components that are executed and run on one or more processors (e.g., processor 910 of FIG. 9 or other processor(s)). In some examples, the process 800 can be performed by an RFID reader and/or RFID energizer, such as the RFID reader 310 of FIG. 3, the RFID reader device 410 of FIG. 4A, the RFID reader device 510 of FIG. 5A and/or FIG. 5B, and/or the RFID reader device 610 of FIG. 6A, etc. In some aspects, the process 800 can be performed by a UE, smartphone, mobile computing device, user computer device, etc., that includes and/or implements an RFID reader (e.g., RFID energizer). In some examples, the process 800 can be performed by a computing device that includes an SoC configured to implement and/or including an RFID reader (e.g., RFID energizer). In some cases, the process 800 can be performed by an RFID reader (e.g., RFID energizer) included in or associated with a basket. For instance, the process 800 can be performed by an RFID reader included in or attached to a handheld shopping basket, cart, trolley, etc.

At block 802, the computing device (or component thereof) can determine a frequency hopping configuration corresponding to a plurality of frequency hops between a plurality of carrier frequencies.

For example, the computing device can be a wireless communication device associated with PBR measurements for the RFID tag. In some examples, the computing device is a wireless communication device comprising an RFID reader device configured to transmit and receive RFID signals. For example, the computing device can be an RFID reader device such as the RFID reader 310 of FIG. 3, 410 of FIG. 4A, 510 of FIG. 5A-5B, 610 of FIG. 6A, etc. In some cases, the RFID tag can be the same as or similar to the RFID tag 350 of FIG. 3; the RFID tag 442 of FIG. 4A; the RFID tag 540 of FIGS. 5A and 5B; the RFID tag 640 of FIG. 6A; etc.

In some cases, the frequency hopping configuration includes timing information for performing the plurality of frequency hops, and each frequency hop is between a first carrier frequency and a second carrier frequency of the plurality of carrier frequencies. For example, the plurality of carrier frequencies can include and/or can be based on the carrier frequencies f in the graph 480 of FIG. 4B; the plurality of carrier frequencies 530 (e.g., C₀, . . . , C_{N-1}) of FIG. 5B and FIG. 5C; the plurality of reader CW frequencies on the vertical axis of the graph 700 of FIG. 7; etc.

In some cases, the computing device (or component thereof) is configured to perform each frequency hop at a time associated with a symbol boundary between consecutive symbols included in preamble modulated onto the continuous backscatter signal by the RFID tag. For examples, the preamble can be the same as or similar to the preamble 600b of FIG. 6B, and/or the preamble 722 and/or 726 of FIG. 7, etc. In some cases, the symbol boundaries can correspond to the boundaries between the symbols 705-0, 705-1, . . . , 705-9 of FIG. 7, etc. In some cases, the computing device is a wireless communication device comprising an RFID reader device configured to transmit and receive RFID signals.

At block 804, the computing device (or component thereof) can transmit a continuous carrier signal to a Radio Frequency Identification (RFID) tag, wherein the continuous carrier signal comprises a pilot tone transmitted on each respective carrier frequency of the plurality of carrier frequencies.

For example, the continuous carrier signal can be the same as or similar to the transmitted signal 42 of FIG. 4A, the carrier wave transmission(s) 530 of FIG. 5B, the continuous CW signal 602 of FIG. 6A, etc. The pilot tone can be the same as or similar to a pilot tone associated with the backscatter pilot tone 550 of FIG. 5B, and can be transmitted on the plurality of carrier frequencies 530 of FIG. 5B. The pilot tone may be the same as or similar to a pilot tone transmitted between the reader 610 and the RFID tag 640 of FIG. 6B, etc.

In some cases, to transmit the continuous carrier signal, the computing device (or component thereof) is configured to successively transmit the pilot tone on each respective carrier frequency of the plurality of carrier frequencies. In some examples, the pilot tone is a single pilot tone transmitted between the wireless communication device and the RFID tag, and the computing device (or component thereof) is configured to obtain the plurality of relative phase measurements within a single pilot tone period associated with the single pilot tone.

At block 806, the computing device (or component thereof) can receive, from the RFID tag, a continuous backscatter signal including a corresponding reflection of the pilot tone transmitted on each respective carrier frequency of the plurality of carrier frequencies.

For example, the continuous backscatter signal can be the same as or similar to the backscatter pilot tone 550 received by the RFID reader device 510 from the RFID tag 540 of FIG. 5B, etc. In some cases, the continuous backscatter signal is indicative of a plurality of preamble symbols included in a response transmitted from the RFID tag to the wireless communication device. In some cases, the plurality of frequency hops are aligned with symbol boundaries associated with the plurality of preamble symbols. In some examples, a number of frequency hops included in the plurality of frequency hops is equal to a number of preamble symbols included in the plurality of preamble symbols.

In some cases, the computing device (or component thereof) can receive an initial backscatter signal from the RFID tag, where the initial backscatter signal is a response to an RFID Query command transmitted by the wireless communication device. The computing device (or component thereof) can determine a timing estimation error of the RFID tag based on the initial backscatter signal. The computing device (or component thereof) can determine the frequency hopping configuration based at least in part on the timing estimation error.

In some examples, the initial backscatter signal comprises an RN16 message transmitted by the RFID tag in response to the RFID Query command. For example, the RN16 message can be the same as or similar to the RN16 message 645 of FIG. 6A. In some examples, the computing device (or component thereof) can determine a predicted packet arrival time based on the timing estimation error, where the predicted packet arrival time corresponds to a first preamble symbol of a subsequent message transmitted by the RFID tag. In some examples, the computing device (or component thereof) can perform the plurality of frequency hops between the plurality of carrier frequencies for the continuous carrier signal beginning from the predicted packet arrival time. In some case, a frequency hopping duration associated with performing the plurality of frequency hops is greater than or equal to a preamble length of a message modulated on the continuous backscatter signal by the RFID tag.

At block 808, the computing device (or component thereof) can determine an estimated distance from the wireless communication device to the RFID tag based on a plurality of measurements obtained from the continuous backscatter signal. For example, the plurality of measurements can comprise a plurality of relative phase measurements obtained from the continuous backscatter signal.

In some examples, the estimated distance is determined using phase-based ranging and the plurality of relative phase measurements obtained from the continuous backscatter signal. In some cases, each relative phase measurement of the plurality of relative phase measurements comprises a phase change measurement between a transmitted phase associated with the pilot tone transmitted on a particular carrier frequency and a received phase associated with the reflection of the pilot tone transmitted on the particular carrier frequency.

The network entity, network device, and/or the wireless communication device may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of a device configured to perform the process 800 of FIG. 8 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 800 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 800 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a block diagram illustrating an example of a computing system 900, which may be employed by the disclosed systems and techniques. In particular, FIG. 9 illustrates an example of computing system 900, which can be, for example, any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 900 includes at least one processing unit (CPU or processor) 910 and connection 905 that communicatively couples various system components including system memory 915, such as read-only memory (ROM) 920 and random-access memory (RAM) 925 to processor 910. Computing system 900 can include a cache 912 of high-speed memory connected directly with, in close proximity to, or integrated as part of processor 910.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900.

Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 940 may also include one or more range sensors (e.g., LIDAR sensors, laser range finders, RF radars, ultrasonic sensors, and infrared (IR) sensors) configured to collect data and provide measurements to processor 910, whereby processor 910 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A wireless communication device for wireless communications, the wireless communication device comprising: at least one memory; and at least one processor coupled to the at least one memory and configured to: determine a frequency hopping configuration corresponding to a plurality of frequency hops between a plurality of carrier frequencies; transmit a continuous carrier signal to a Radio Frequency Identification (RFID) tag, wherein the continuous carrier signal comprises a pilot tone transmitted on each respective carrier frequency of the plurality of carrier frequencies; receive, from the RFID tag, a continuous backscatter signal including a corresponding reflection of the pilot tone transmitted on each respective carrier frequency of the plurality of carrier frequencies; and determine an estimated distance from the wireless communication device to the RFID tag based on a plurality of measurements obtained from the continuous backscatter signal.

Aspect 2. The wireless communication device of Aspect 1, wherein: the continuous backscatter signal is indicative of a plurality of preamble symbols included in a response transmitted from the RFID tag to the wireless communication device; and the plurality of frequency hops are aligned with symbol boundaries associated with the plurality of preamble symbols.

Aspect 3. The wireless communication device of Aspect 2, wherein: a number of frequency hops included in the plurality of frequency hops is equal to a number of preamble symbols included in the plurality of preamble symbols.

Aspect 4. The wireless communication device of any of Aspects 1 to 3, wherein the frequency hopping configuration includes timing information for performing the plurality of frequency hops, wherein each frequency hop is between a first carrier frequency and a second carrier frequency of the plurality of carrier frequencies.

Aspect 5. The wireless communication device of Aspect 4, wherein the at least one processor is configured to perform each frequency hop at a time associated with a symbol boundary between consecutive symbols included in preamble modulated onto the continuous backscatter signal by the RFID tag.

Aspect 6. The wireless communication device of any of Aspects 1 to 5, wherein the at least one processor is configured to: receive an initial backscatter signal from the RFID tag, wherein the initial backscatter signal is a response to an RFID Query command transmitted by the wireless communication device; determine a timing estimation error of the RFID tag based on the initial backscatter signal; and determine the frequency hopping configuration based at least in part on the timing estimation error.

Aspect 7. The wireless communication device of Aspect 6, wherein: the initial backscatter signal comprises an RN16 message transmitted by the RFID tag in response to the RFID Query command; and the at least one processor is configured to determine a predicted packet arrival time based on the timing estimation error, wherein the predicted packet arrival time corresponds to a first preamble symbol of a subsequent message transmitted by the RFID tag.

Aspect 8. The wireless communication device of Aspect 7, wherein the at least one processor is configured to perform the plurality of frequency hops between the plurality of carrier frequencies for the continuous carrier signal beginning from the predicted packet arrival time.

Aspect 9. The wireless communication device of any of Aspects 1 to 8, wherein a frequency hopping duration associated with performing the plurality of frequency hops is greater than or equal to a preamble length of a message modulated on the continuous backscatter signal by the RFID tag.

Aspect 10. The wireless communication device of any of Aspects 1 to 9, wherein the plurality of measurements comprises a plurality of relative phase measurements obtained from the continuous backscatter signal.

Aspect 11. The wireless communication device of Aspect 10, wherein the estimated distance is determined using phase-based ranging and the plurality of relative phase measurements obtained from the continuous backscatter signal.

Aspect 12. The wireless communication device of Aspect 11, wherein each relative phase measurement of the plurality of relative phase measurements comprises a phase change measurement between a transmitted phase associated with the pilot tone transmitted on a particular carrier frequency and a received phase associated with the reflection of the pilot tone transmitted on the particular carrier frequency.

Aspect 13. The wireless communication device of any of Aspects 1 to 12, wherein, to transmit the continuous carrier signal, the at least one processor is configured to successively transmit the pilot tone on each respective carrier frequency of the plurality of carrier frequencies.

Aspect 14. The wireless communication device of any of Aspects 1 to 13, wherein: the plurality of measurements comprises a plurality of relative phase measurements obtained from the continuous backscatter signal; the pilot tone is a single pilot tone transmitted between the wireless communication device and the RFID tag; and the at least one processor is configured to obtain the plurality of relative phase measurements within a single pilot tone period associated with the single pilot tone.

Aspect 15. The wireless communication device of any of Aspects 1 to 13, wherein the wireless communication device comprises an RFID reader device configured to transmit and receive RFID signals.

Aspect 16. A method for wireless communications, the method comprising: determining a frequency hopping configuration corresponding to a plurality of frequency hops between a plurality of carrier frequencies; transmitting a continuous carrier signal to a Radio Frequency Identification (RFID) tag, wherein the continuous carrier signal comprises a pilot tone transmitted on each respective carrier frequency of the plurality of carrier frequencies; receiving, from the RFID tag, a continuous backscatter signal including a corresponding reflection of the pilot tone transmitted on each respective carrier frequency of the plurality of carrier frequencies; and determining an estimated distance from a wireless communication device to the RFID tag based on a plurality of measurements obtained from the continuous backscatter signal.

Aspect 17. The method of Aspect 16, wherein: the continuous backscatter signal is indicative of a plurality of preamble symbols included in a response transmitted from the RFID tag to the wireless communication device; and the plurality of frequency hops are aligned with symbol boundaries associated with the plurality of preamble symbols.

Aspect 18. The method of Aspect 17, wherein: a number of frequency hops included in the plurality of frequency hops is equal to a number of preamble symbols included in the plurality of preamble symbols.

Aspect 19. The method of any of Aspects 16 to 18, wherein the frequency hopping configuration includes timing information for performing the plurality of frequency hops, wherein each frequency hop is between a first carrier frequency and a second carrier frequency of the plurality of carrier frequencies.

Aspect 20. The method of Aspect 19, further comprising performing each frequency hop at a time associated with a symbol boundary between consecutive symbols included in preamble modulated onto the continuous backscatter signal by the RFID tag.

Aspect 21. The method of any of Aspects 16 to 20, further comprising: receiving an initial backscatter signal from the RFID tag, wherein the initial backscatter signal is a response to an RFID Query command transmitted by the wireless communication device; determining a timing estimation error of the RFID tag based on the initial backscatter signal; and determining the frequency hopping configuration based at least in part on the timing estimation error.

Aspect 22. The method of Aspect 21 wherein the initial backscatter signal comprises an RN16 message transmitted by the RFID tag in response to the RFID Query command, the method further comprising determining a predicted packet arrival time based on the timing estimation error, wherein the predicted packet arrival time corresponds to a first preamble symbol of a subsequent message transmitted by the RFID tag.

Aspect 23. The method of Aspect 22, further comprising performing the plurality of frequency hops between the plurality of carrier frequencies for the continuous carrier signal beginning from the predicted packet arrival time.

Aspect 24. The method of any of Aspects 16 to 23, wherein a frequency hopping duration associated with performing the plurality of frequency hops is greater than or equal to a preamble length of a message modulated on the continuous backscatter signal by the RFID tag.

Aspect 25. The method of any of Aspects 16 to 24, wherein the plurality of measurements comprises a plurality of relative phase measurements obtained from the continuous backscatter signal.

Aspect 26. The method of Aspect 25, wherein the estimated distance is determined using phase-based ranging and the plurality of relative phase measurements obtained from the continuous backscatter signal.

Aspect 27. The method of Aspect 26, wherein each relative phase measurement of the plurality of relative phase measurements comprises a phase change measurement between a transmitted phase associated with the pilot tone transmitted on a particular carrier frequency and a received phase associated with the reflection of the pilot tone transmitted on the particular carrier frequency.

Aspect 28. The method of any of Aspects 16 to 27, wherein transmitting the continuous carrier signal comprises successively transmitting the pilot tone on each respective carrier frequency of the plurality of carrier frequencies.

Aspect 29. The method of any of Aspects 16 to 28, wherein the pilot tone is a single pilot tone transmitted between the wireless communication device and the RFID tag, the method further comprising obtaining the plurality of relative phase measurements within a single pilot tone period associated with the single pilot tone.

Aspect 30. A non-transitory computer-readable medium having code stored thereon that, when executed by an apparatus, causes the apparatus to: determine a frequency hopping configuration corresponding to a plurality of frequency hops between a plurality of carrier frequencies; transmit a continuous carrier signal to a Radio Frequency Identification (RFID) tag, wherein the continuous carrier signal comprises a pilot tone transmitted on each respective carrier frequency of the plurality of carrier frequencies; receive, from the RFID tag, a continuous backscatter signal including a corresponding reflection of the pilot tone transmitted on each respective carrier frequency of the plurality of carrier frequencies; and determine an estimated distance from the apparatus to the RFID tag based on a plurality of measurements obtained from the continuous backscatter signal.

Aspect 31. The non-transitory computer-readable medium of Aspect 30, wherein: the continuous backscatter signal is indicative of a plurality of preamble symbols included in a response transmitted from the RFID tag to the apparatus; and the plurality of frequency hops are aligned with symbol boundaries associated with the plurality of preamble symbols.

Aspect 32. The non-transitory computer-readable medium of Aspect 31, wherein: a number of frequency hops included in the plurality of frequency hops is equal to a number of preamble symbols included in the plurality of preamble symbols.

Aspect 33. The non-transitory computer-readable medium of any of Aspects 30 to 32, wherein the frequency hopping configuration includes timing information for performing the plurality of frequency hops, wherein each frequency hop is between a first carrier frequency and a second carrier frequency of the plurality of carrier frequencies.

Aspect 34. The non-transitory computer-readable medium of Aspect 33, wherein the apparatus is configured to perform each frequency hop at a time associated with a symbol boundary between consecutive symbols included in preamble modulated onto the continuous backscatter signal by the RFID tag.

Aspect 35. The non-transitory computer-readable medium of any of Aspects 30 to 34, wherein the apparatus is configured to: receive an initial backscatter signal from the RFID tag, wherein the initial backscatter signal is a response to an RFID Query command transmitted by the apparatus; determine a timing estimation error of the RFID tag based on the initial backscatter signal; and determine the frequency hopping configuration based at least in part on the timing estimation error.

Aspect 36. The non-transitory computer-readable medium of Aspect 33, wherein: the initial backscatter signal comprises an RN16 message transmitted by the RFID tag in response to the RFID Query command; and the apparatus is configured to determine a predicted packet arrival time based on the timing estimation error, wherein the predicted packet arrival time corresponds to a first preamble symbol of a subsequent message transmitted by the RFID tag.

Aspect 37. The non-transitory computer-readable medium of Aspect 34, wherein the apparatus is configured to perform the plurality of frequency hops between the plurality of carrier frequencies for the continuous carrier signal beginning from the predicted packet arrival time.

Aspect 36. 38 non-transitory computer-readable medium of any of Aspects 30 to 37, wherein a frequency hopping duration associated with performing the plurality of frequency hops is greater than or equal to a preamble length of a message modulated on the continuous backscatter signal by the RFID tag.

Aspect 39. The non-transitory computer-readable medium of any of Aspects 30 to 38, wherein the plurality of measurements comprises a plurality of relative phase measurements obtained from the continuous backscatter signal.

Aspect 40. The non-transitory computer-readable medium of Aspect 39, wherein the estimated distance is determined using phase-based ranging and the plurality of relative phase measurements obtained from the continuous backscatter signal.

Aspect 41. The non-transitory computer-readable medium of Aspect 40, wherein each relative phase measurement of the plurality of relative phase measurements comprises a phase change measurement between a transmitted phase associated with the pilot tone transmitted on a particular carrier frequency and a received phase associated with the reflection of the pilot tone transmitted on the particular carrier frequency.

Aspect 42. The non-transitory computer-readable medium of any of Aspects 30 to 41, wherein, to transmit the continuous carrier signal, the apparatus is configured to successively transmit the pilot tone on each respective carrier frequency of the plurality of carrier frequencies.

Aspect 43. The non-transitory computer-readable medium of any of Aspects 30 to 42, wherein the pilot tone is a single pilot tone transmitted between the apparatus and the RFID tag, and wherein the apparatus is configured to obtain the plurality of relative phase measurements within a single pilot tone period associated with the single pilot tone.

Aspect 44. The non-transitory computer-readable medium of any of Aspects 30 to 43, wherein the apparatus comprises an RFID reader device configured to transmit and receive RFID signals.

Aspect 45. A method for wireless communication, comprising performing operations according to any of Aspects 1 to 14 or 30 to 44.

Aspect 46. A non-transitory computer-readable storage medium comprising instructions stored thereon which, when executed by at least one processor, causes the at least one processor to perform operations according to any of Aspects 1 to 15 or 16 to 29.

Aspect 47. An apparatus for wireless communication comprising one or more means for performing operations according to any of Aspects 1 to 15.

Aspect 48. An apparatus for wireless communication comprising one or more means for performing operations according to any of Aspects 16 to 29.

Aspect 49. An apparatus for wireless communication comprising one or more means for performing operations according to any of Aspects 30 to 44.

What is claimed is:

1. A wireless communication device for wireless communications, the wireless communication device comprising:
at least one memory; and
at least one processor coupled to the at least one memory and configured to:
determine a frequency hopping configuration corresponding to a plurality of frequency hops between a plurality of carrier frequencies;
transmit a continuous carrier signal to a Radio Frequency Identification (RFID) tag, wherein the continuous carrier signal comprises a pilot tone transmitted on each respective carrier frequency of the plurality of carrier frequencies;
receive, from the RFID tag, a continuous backscatter signal including a corresponding reflection of the pilot tone transmitted on each respective carrier frequency of the plurality of carrier frequencies; and
determine an estimated distance from the wireless communication device to the RFID tag based on a plurality of measurements obtained from the continuous backscatter signal.

2. The wireless communication device of claim 1, wherein:
the continuous backscatter signal is indicative of a plurality of preamble symbols included in a response transmitted from the RFID tag to the wireless communication device; and
the plurality of frequency hops are aligned with symbol boundaries associated with the plurality of preamble symbols.

3. The wireless communication device of claim 2, wherein:
a number of frequency hops included in the plurality of frequency hops is equal to a number of preamble symbols included in the plurality of preamble symbols.

4. The wireless communication device of claim 1, wherein the frequency hopping configuration includes timing information for performing the plurality of frequency hops, wherein each frequency hop is between a first carrier frequency and a second carrier frequency of the plurality of carrier frequencies.

5. The wireless communication device of claim 4, wherein the at least one processor is configured to perform each frequency hop at a time associated with a symbol boundary between consecutive symbols included in preamble modulated onto the continuous backscatter signal by the RFID tag.

6. The wireless communication device of claim 1, wherein the at least one processor is configured to:
receive an initial backscatter signal from the RFID tag, wherein the initial backscatter signal is a response to an RFID Query command transmitted by the wireless communication device;
determine a timing estimation error of the RFID tag based on the initial backscatter signal; and
determine the frequency hopping configuration based at least in part on the timing estimation error.

7. The wireless communication device of claim 6, wherein:
the initial backscatter signal comprises an RN16 message transmitted by the RFID tag in response to the RFID Query command; and
the at least one processor is configured to determine a predicted packet arrival time based on the timing estimation error, wherein the predicted packet arrival time corresponds to a first preamble symbol of a subsequent message transmitted by the RFID tag.

8. The wireless communication device of claim 7, wherein the at least one processor is configured to perform the plurality of frequency hops between the plurality of carrier frequencies for the continuous carrier signal beginning from the predicted packet arrival time.

9. The wireless communication device of claim 1, wherein a frequency hopping duration associated with performing the plurality of frequency hops is greater than or equal to a preamble length of a message modulated on the continuous backscatter signal by the RFID tag.

10. The wireless communication device of claim 1, wherein the plurality of measurements comprises a plurality of relative phase measurements obtained from the continuous backscatter signal.

11. The wireless communication device of claim 10, wherein the estimated distance is determined using phase-based ranging and the plurality of relative phase measurements obtained from the continuous backscatter signal.

12. The wireless communication device of claim 11, wherein each relative phase measurement of the plurality of relative phase measurements comprises a phase change measurement between a transmitted phase associated with the pilot tone transmitted on a particular carrier frequency and a received phase associated with the reflection of the pilot tone transmitted on the particular carrier frequency.

13. The wireless communication device of claim 1, wherein, to transmit the continuous carrier signal, the at least one processor is configured to successively transmit the pilot tone on each respective carrier frequency of the plurality of carrier frequencies.

14. The wireless communication device of claim 1, wherein:
the plurality of measurements comprises a plurality of relative phase measurements obtained from the continuous backscatter signal;
the pilot tone is a single pilot tone transmitted between the wireless communication device and the RFID tag; and
the at least one processor is configured to obtain the plurality of relative phase measurements within a single pilot tone period associated with the single pilot tone.

15. The wireless communication device of claim 1, wherein the wireless communication device comprises an RFID reader device configured to transmit and receive RFID signals.

16. A method for wireless communications, the method comprising:
determining a frequency hopping configuration corresponding to a plurality of frequency hops between a plurality of carrier frequencies;
transmitting a continuous carrier signal to a Radio Frequency Identification (RFID) tag, wherein the continuous carrier signal comprises a pilot tone transmitted on each respective carrier frequency of the plurality of carrier frequencies;
receiving, from the RFID tag, a continuous backscatter signal including a corresponding reflection of the pilot tone transmitted on each respective carrier frequency of the plurality of carrier frequencies; and
determining an estimated distance from a wireless communication device to the RFID tag based on a plurality of measurements obtained from the continuous backscatter signal.

17. The method of claim 16, wherein:
the continuous backscatter signal is indicative of a plurality of preamble symbols included in a response transmitted from the RFID tag to the wireless communication device; and
the plurality of frequency hops are aligned with symbol boundaries associated with the plurality of preamble symbols.

18. The method of claim 17, wherein:
a number of frequency hops included in the plurality of frequency hops is equal to a number of preamble symbols included in the plurality of preamble symbols.

19. The method of claim 16, wherein the frequency hopping configuration includes timing information for performing the plurality of frequency hops, wherein each frequency hop is between a first carrier frequency and a second carrier frequency of the plurality of carrier frequencies.

20. The method of claim 19, further comprising performing each frequency hop at a time associated with a symbol boundary between consecutive symbols included in preamble modulated onto the continuous backscatter signal by the RFID tag.

21. The method of claim 16, further comprising:
receiving an initial backscatter signal from the RFID tag, wherein the initial backscatter signal is a response to an RFID Query command transmitted by the wireless communication device;
determining a timing estimation error of the RFID tag based on the initial backscatter signal; and
determining the frequency hopping configuration based at least in part on the timing estimation error.

22. The method of claim 21, wherein the initial backscatter signal comprises an RN16 message transmitted by the RFID tag in response to the RFID Query command, the method further comprising determining a predicted packet arrival time based on the timing estimation error, wherein the predicted packet arrival time corresponds to a first preamble symbol of a subsequent message transmitted by the RFID tag

23. The method of claim 22, further comprising performing the plurality of frequency hops between the plurality of carrier frequencies for the continuous carrier signal beginning from the predicted packet arrival time.

24. The method of claim 16, wherein a frequency hopping duration associated with performing the plurality of frequency hops is greater than or equal to a preamble length of a message modulated on the continuous backscatter signal by the RFID tag.

25. The method of claim 16, wherein the plurality of measurements comprises a plurality of relative phase measurements obtained from the continuous backscatter signal.

26. The method of claim 25, wherein the estimated distance is determined using phase-based ranging and the plurality of relative phase measurements obtained from the continuous backscatter signal.

27. The method of claim 26, wherein each relative phase measurement of the plurality of relative phase measurements comprises a phase change measurement between a transmitted phase associated with the pilot tone transmitted on a particular carrier frequency and a received phase associated with the reflection of the pilot tone transmitted on the particular carrier frequency.

28. The method of claim 16, wherein:
the plurality of measurements comprises a plurality of relative phase measurements obtained from the continuous backscatter signal;
the pilot tone is a single pilot tone transmitted between the wireless communication device and the RFID tag; and
the plurality of relative phase measurements are obtained within a single pilot tone period associated with the single pilot tone.

29. A non-transitory computer-readable medium having code stored thereon that, when executed by an apparatus, causes the apparatus to:
determine a frequency hopping configuration corresponding to a plurality of frequency hops between a plurality of carrier frequencies;
transmit a continuous carrier signal to a Radio Frequency Identification (RFID) tag, wherein the continuous carrier signal comprises a pilot tone transmitted on each respective carrier frequency of the plurality of carrier frequencies;
receive, from the RFID tag, a continuous backscatter signal including a corresponding reflection of the pilot tone transmitted on each respective carrier frequency of the plurality of carrier frequencies; and
determine an estimated distance from the apparatus to the RFID tag based on a plurality of measurements obtained from the continuous backscatter signal.

30. The non-transitory computer-readable medium of claim 29, wherein the plurality of measurements comprises a plurality of relative phase measurements obtained from the continuous backscatter signal.
